(19) United States
(12) Patent Application Publication
(10) Pub. No.: US 2026/0230242 A1
(43) Pub. Date: Aug. 6, 2026

(54) PUNCTURING AND POSTPONEMENT OF UPLINK TRANSMISSIONS WITH ORTHOGONAL COVER CODING

(71) Applicant: QUALCOMM Incorporated, San Diego, CA (US)

(72) Inventors: Syed Hashim Ali SHAH, Littleton, MA (US); Ayan SENGUPTA, Mountain View, CA (US); Alberto RICO ALVARINO, San Diego, CA (US)

(21) Appl. No.: 19/447,843

(22) Filed: Jan. 13, 2026

Related U.S. Application Data
(60) Provisional application No. 63/754,928, filed on Feb. 6, 2025.

(51) Int. Cl. H04L 5/00; H04W 72/21

(52) U.S. Cl. CPC H04L 5/0007; H04W 72/21

(57) ABSTRACT

Methods, systems, and devices for wireless communications are described. A user equipment (UE) and/or a network entity may determine whether to puncture resources within one or more repetitions of an uplink transmission scheduled for performance in accordance with an orthogonal cover coder configuration or whether to postpone the one or more repetitions of an uplink transmission based on whether the quantity of resources that would be punctured exceeds a threshold. For example, the resources may be associated with a scheduling conflict, such as resources scheduled for sounding reference signal transmissions, resources reserved for New Radio communications, and/or resources associated with a pre-compensation gap for the UE. The threshold may relate to whether the network entity is able to combine and successfully decode the multiple repetitions even though some of the resources are punctured.

### CROSS REFERENCES

The present application for patent claims benefit of U.S. Provisional Patent Application No. 63/754,928 by SHAH et al., entitled “PUNCTURING AND POSTPONEMENT OF UPLINK TRANSMISSIONS WITH ORTHOGONAL COVER CODING,” filed Feb. 6, 2025, assigned to the assignee hereof, and expressly incorporated by reference herein.

### FIELD OF TECHNOLOGY

The following relates to wireless communications, including puncturing and postponement of uplink transmissions with orthogonal cover coding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an orthogonal cover code (OCC) configuration and performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled demodulation reference signals (DMRSs) within the at least the subset of resources, where at least a portion of the second set of resources is subsequent in time to the first set of resources.

A UE for wireless communications is described. The UE may include one or more memories storing processor executable code, and one or more processors coupled with the one or more memories. The one or more processors may individually or collectively be operable to execute the code to cause the UE to receive, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration and perform the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

Another UE for wireless communications is described. The UE may include means for receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration and means for performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

A non-transitory computer-readable medium storing code for wireless communications is described. The code may include instructions executable by one or more processors to receive, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration and perform the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

In some examples of the method, UEs, and non-transitory computer-readable medium described herein, performing the set of repetitions of the uplink transmission may include operations, features, means, or instructions for performing the set of repetitions of the uplink transmission via the first set of resources based on the at least the subset of resources being less than or equal to the threshold quantity of resources, where respective portions of the set of repetitions of the uplink transmission scheduled in the at least the subset of resources may be dropped in accordance with the scheduling conflict.

In some examples of the method, UEs, and non-transitory computer-readable medium described herein, performing the set of repetitions of the uplink transmission may include operations, features, means, or instructions for performing the set of repetitions of the uplink transmission via the second set of resources based on the at least the subset of resources being greater than the threshold quantity of resources.

In some examples of the method, UEs, and non-transitory computer-readable medium described herein, a totality of the second set of resources may be subsequent in time to the first set of resources.

In some examples of the method, UEs, and non-transitory computer-readable medium described herein, a temporally first time resource of the first set of resources may be the same as a temporally first time resource of the second set of resources, a temporally second time resource of the second set of resources may be subsequent in time to a temporally second time resource of the first set of resources, and the temporally second time resource of the first set of resources includes one or more resources of the at least the subset of resources.

In some examples of the method, UEs, and non-transitory computer-readable medium described herein, the OCC configuration indicates a multiplexing order and an OCC to apply to the set of repetitions of the uplink transmission and a total quantity of repetitions of the set of repetitions of the uplink transmission may be greater than or equal to the multiplexing order.

In some examples of the method, UEs, and non-transitory computer-readable medium described herein, the second set of resources may be a temporally next subsequent set of resources associated with the uplink transmission after the first set of resources without a respective scheduling conflict.

In some examples of the method, UEs, and non-transitory computer-readable medium described herein, the threshold quantity of resources may be based on a subcarrier spacing (SCS) associated with the set of repetitions of the uplink transmission, a time-domain granularity associated with the OCC configuration, a multiplexing order associated with the OCC configuration, or a combination thereof.

In some examples of the method, UEs, and non-transitory computer-readable medium described herein, the threshold quantity of resources includes a threshold quantity of symbols.

Some examples of the method, UEs, and non-transitory computer-readable medium described herein may further include operations, features, means, or instructions for receiving an indication of a third set of resources associated with a second radio access technology (RAT), where the set of repetitions of the uplink transmission may be associated with a first RAT, and where the scheduling conflict may be based on the at least the subset of resources being included within the third set of resources.

Some examples of the method, UEs, and non-transitory computer-readable medium described herein may further include operations, features, means, or instructions for receiving an indication of a third set of resources associated with sounding reference signal (SRS) transmission, where the scheduling conflict may be based on the at least the subset of resources being included within the third set of resources.

Some examples of the method, UEs, and non-transitory computer-readable medium described herein may further include operations, features, means, or instructions for identifying a third set of resources associated with a pre-compensation gap associated with segmented pre-compensation for communicating with non-terrestrial networks for the UE, where the scheduling conflict may be based on the at least the subset of resources being included within the third set of resources.

Some examples of the method, UEs, and non-transitory computer-readable medium described herein may further include operations, features, means, or instructions for receiving, via the control signaling or second control signaling, an indication of the threshold quantity of resources.

In some examples of the method, UEs, and non-transitory computer-readable medium described herein, performing the set of repetitions of the uplink transmission may include operations, features, means, or instructions for performing the set of repetitions of the uplink transmission via the first set of resources based on the absence of the one or more scheduled DMRSs within the at least the subset of resources.

In some examples of the method, UEs, and non-transitory computer-readable medium described herein, performing the set of repetitions of the uplink transmission may include operations, features, means, or instructions for performing the set of repetitions of the uplink transmission via the second set of resources based on the presence of one or more scheduled DMRSs within the at least the subset of resources.

A method for wireless communications by a network entity is described. The method may include outputting, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration and obtaining, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

A network entity for wireless communications is described. The network entity may include one or more memories storing processor executable code, and one or more processors coupled with the one or more memories. The one or more processors may individually or collectively be operable to execute the code to cause the network entity to output, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration and obtain, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

Another network entity for wireless communications is described. The network entity may include means for outputting, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration and means for obtaining, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

A non-transitory computer-readable medium storing code for wireless communications is described. The code may include instructions executable by one or more processors to output, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration and obtain, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

In some examples of the method, network entities, and non-transitory computer-readable medium described herein, obtaining the set of repetitions of the uplink transmission may include operations, features, means, or instructions for obtaining the set of repetitions of the uplink transmission via the first set of resources based on the at least the subset of resources being less than or equal to the threshold quantity of resources, where respective portions of the set of repetitions of the uplink transmission scheduled in the at least the subset of resources may be dropped in accordance with the scheduling conflict.

In some examples of the method, network entities, and non-transitory computer-readable medium described herein, obtaining the set of repetitions of the uplink transmission may include operations, features, means, or instructions for obtaining the set of repetitions of the uplink transmission via the second set of resources based on the at least the subset of resources being greater than the threshold quantity of resources.

In some examples of the method, network entities, and non-transitory computer-readable medium described herein, a totality of the second set of resources may be subsequent in time to the first set of resources.

In some examples of the method, network entities, and non-transitory computer-readable medium described herein, a temporally first time resource of the first set of resources may be the same as a temporally first time resource of the second set of resources, a temporally second time resource of the second set of resources may be subsequent in time to a temporally second time resource of the first set of resources, and the temporally second time resource of the first set of resources includes one or more resources of the at least the subset of resources.

In some examples of the method, network entities, and non-transitory computer-readable medium described herein, the OCC configuration indicates a multiplexing order and an OCC to apply to the set of repetitions of the uplink transmission and a total quantity of repetitions of the set of repetitions of the uplink transmission may be greater than or equal to the multiplexing order.

In some examples of the method, network entities, and non-transitory computer-readable medium described herein, the second set of resources may be a temporally next subsequent set of resources associated with the uplink transmission after the first set of resources without a respective scheduling conflict.

In some examples of the method, network entities, and non-transitory computer-readable medium described herein, the threshold quantity of resources may be based on a SCS associated with the set of repetitions of the uplink transmission, a time-domain granularity associated with the OCC configuration, a multiplexing order associated with the OCC configuration, or a combination thereof.

In some examples of the method, network entities, and non-transitory computer-readable medium described herein, the threshold quantity of resources includes a threshold quantity of symbols.

Some examples of the method, network entities, and non-transitory computer-readable medium described herein may further include operations, features, means, or instructions for obtaining an indication of a third set of resources associated with a second RAT, where the set of repetitions of the uplink transmission may be associated with a first RAT, and where the scheduling conflict may be based on the at least the subset of resources being included within the third set of resources.

Some examples of the method, network entities, and non-transitory computer-readable medium described herein may further include operations, features, means, or instructions for obtaining an indication of a third set of resources associated with SRS transmission, where the scheduling conflict may be based on the at least the subset of resources being included within the third set of resources.

Some examples of the method, network entities, and non-transitory computer-readable medium described herein may further include operations, features, means, or instructions for identifying a third set of resources associated with a pre-compensation gap associated with segmented pre-compensation for communicating with non-terrestrial networks for the UE, where the scheduling conflict may be based on the at least the subset of resources being included within the third set of resources.

Some examples of the method, network entities, and non-transitory computer-readable medium described herein may further include operations, features, means, or instructions for outputting, for the UE and via the control signaling or second control signaling, an indication of the threshold quantity of resources.

Some examples of the method, network entities, and non-transitory computer-readable medium described herein may further include operations, features, means, or instructions for outputting, for a second UE, second control signaling that indicates second scheduling information for a second set of repetitions of a second uplink transmission, where the second scheduling information indicates the first set of resources for the second set of repetitions of the second uplink transmission, and where the second scheduling information indicates to perform the second set of repetitions of the second uplink transmission in accordance with a second OCC configuration and obtaining, in association with the second UE, the second set of repetitions of the second uplink transmission in accordance with the second OCC configuration via the first set of resources or via the second set of resources based on whether the at least the subset of resources exceeds the threshold quantity of resources.

In some examples of the method, network entities, and non-transitory computer-readable medium described herein, obtaining the set of repetitions of the uplink transmission may include operations, features, means, or instructions for obtaining the set of repetitions of the uplink transmission via the first set of resources based on the absence of the one or more scheduled DMRSs within the at least the subset of resources.

In some examples of the method, network entities, and non-transitory computer-readable medium described herein, obtaining the set of repetitions of the uplink transmission may include operations, features, means, or instructions for obtaining the set of repetitions of the uplink transmission via the second set of resources based on the presence of one or more scheduled DMRSs within the at least the subset of resources.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports puncturing and postponement of uplink transmissions with orthogonal cover coding (OCC) in accordance with one or more aspects of the present disclosure.

FIG. 2A shows an example of an OCC encoding diagram that supports puncturing and postponement of uplink transmissions with OCC in accordance with one or more aspects of the present disclosure.

FIG. 2B shows an example of a resource diagram that supports puncturing and postponement of uplink transmissions with OCC in accordance with one or more aspects of the present disclosure.

FIG. 3 shows examples of resource diagrams that support puncturing and postponement of uplink transmissions with OCC in accordance with one or more aspects of the present disclosure.

FIG. 4 shows an example of a wireless communications system that supports puncturing and postponement of uplink transmissions with OCC in accordance with one or more aspects of the present disclosure.

FIGS. 5A, 5B, and 5C show examples of resource diagrams that supports puncturing and postponement of uplink transmissions with OCC in accordance with one or more aspects of the present disclosure.

FIG. 6 shows an example of a process flow that supports puncturing and postponement of uplink transmissions with OCC in accordance with one or more aspects of the present disclosure.

FIGS. 7 and 8 show block diagrams of devices that support puncturing and postponement of uplink transmissions with OCC in accordance with one or more aspects of the present disclosure.

FIG. 9 shows a block diagram of a communications manager that supports puncturing and postponement of uplink transmissions with OCC in accordance with one or more aspects of the present disclosure.

FIG. 10 shows a diagram of a system including a device that supports puncturing and postponement of uplink transmissions with OCC in accordance with one or more aspects of the present disclosure.

FIGS. 11 and 12 show block diagrams of devices that support puncturing and postponement of uplink transmissions with OCC in accordance with one or more aspects of the present disclosure.

FIG. 13 shows a block diagram of a communications manager that supports puncturing and postponement of uplink transmissions with OCC in accordance with one or more aspects of the present disclosure.

FIG. 14 shows a diagram of a system including a device that supports puncturing and postponement of uplink transmissions with OCC in accordance with one or more aspects of the present disclosure.

FIGS. 15 through 18 show flowcharts illustrating methods that support puncturing and postponement of uplink transmissions with OCC in accordance with one or more aspects of the present disclosure.

### DETAILED DESCRIPTION

In some wireless communications systems, such as in a narrowband internet of things (NB-IoT) system or a non-terrestrial network (NTN) system, a user equipment (UE) may transmit multiple coded copies of data (e.g., repetitions of data). For example, a coded copy of data may be a block of data encoded using an error correcting code that enables a receiving device to detect errors in the transmission of the data block over the channel medium. In some examples, multiple copies of the data may be transmitted to increase the likelihood that the receiver successfully receives the data. In non-orthogonal multiple access (NOMA) schemes, the transmitting UEs may use robust scrambling schemes to transmit via the same time-frequency resources, and the receiving network entity may use a complex receiver design in order to descramble the transmissions received from the multiple UEs via the same time-frequency resources and identify from which UE each transmission was received.

In some examples, however, transmitting UEs may use an orthogonal cover code (OCC) to enable orthogonal M order UE multiplexing (e.g., multiplexing uplink transmissions from M different UEs on the same time-frequency resources) without robust scrambling by the UEs and/or complex receiver design at the network entity. For example, application of an OCC may enable the uplink transmissions from the multiple UEs via the same time-frequency resources to be orthogonal. Use of OCC may involve application of an Mlength OCC codeword across M repetitions of data. For example, a repetition in the context of OCC may refer to a unit of time-frequency resources to which a transport block is mapped. Thus, if the channel coding rate of the UEs is sufficiently low for a given quantity of scheduled repetitions of data (e.g., communications via an NB-IoT or NTN link may be subject to noisy channel conditions that demand multiple repetitions), the UEs may apply the M factor OCC without increasing the amount of time-frequency resources used for the uplink transmissions (such as physical uplink shared channel (PUSCH) transmissions). Accordingly, in OCC, the quantity of time-frequency resources (e.g., the quantity of symbols or slots) may scale with M. An OCC may refer to a coding scheme that enables a receiving device to distinguish multiple users (e.g., UEs) that transmit on the same time-frequency resources via application of orthogonal codewords to the transmitted data by each of the users. The network entity may indicate the OCC factor (e.g., M) and the respective OCC codeword for each UE to use.

Portions of NB-IoT uplink transmissions (e.g., NB-IoT PUSCH (NPUSCH) transmissions) may be dropped or punctured, for example, if the resources for the portions of the NB-IoT uplink transmissions overlap with resources scheduled for sounding reference signal (SRS) transmissions, resources reserved for New Radio (NR) communications, and/or resources associated with a pre-compensation gap for the UE (associated with segmented pre-compensation for communicating with NTNs). Dropping a repetition or portions of a repetition of an uplink transmission coded in accordance with an OCC configuration, however, may result in the network being unable to combine and successfully decode the multiple repetitions. For example, for the network entity to successfully decode an uplink transmission encoded using OCC, the network entity may combine the M repetitions to which the OCC codeword is applied. Accordingly, if some of the repetitions are missing all or portions of the data, the network entity may not be able to successfully decode the uplink transmission.

In some examples, a UE and a network entity may determine whether to puncture resources within one or more repetitions of an uplink transmission scheduled for performance in accordance with an OCC configuration or whether to postpone the one or more repetitions of an uplink transmission based on whether the quantity of resources that would be punctured exceeds a threshold. The resources that would be punctured may be resources that are associated with a scheduling conflict, such as resources scheduled for SRS transmissions, resources reserved for NR communications, and/or resources associated with a pre-compensation gap associated with segmented pre-compensation for communicating with NTNs for the UE. For example, if the quantity of resources that would be punctured are smaller than the threshold, the network entity may be able to combine and successfully decode the multiple repetitions even though some of the resources are punctured. If the quantity of resources that would be punctured is large enough that the network entity would not be able to combine and successfully decode the multiple repetitions, the UE may postpone at least the repetition that would be punctured to a later time resource (e.g., slot) that does not involve a scheduling conflict. The threshold quantity may be associated with the multiplexing order M (e.g., as more repetitions are provided to the network, the network may be able to compensate for more punctured resources). As another example, the threshold quantity may be associated with the subcarrier spacing (SCS) and/or the OCC scheme (e.g., whether slot level or symbol level OCC is applied). In some examples, whether to puncture the resources or whether to postpone the one or more repetitions of an uplink transmission may be based on whether one or more demodulation reference signals (DMRSs) are scheduled within the resources that would be punctured due to the scheduling conflict. For example, dropping scheduled DMRSs may be costly in OCC-based systems, as the DMRSs may themselves be OCC-ed and may occur more sparsely than data. Loss of a DMRS may result in a loss of the ability of the network entity to estimate/determine the de-OCC-ed channels, which may reduce or eliminate the ability of the network entity to decode the corresponding OCC-ed data segment.

Aspects of the disclosure are initially described in the context of wireless communications systems. Aspects of the disclosure are further illustrated by and described with reference to OCC encoding diagrams, resource diagrams, process flows, apparatus diagrams, system diagrams, and flowcharts that relate to puncturing and postponement of uplink transmissions with OCC.

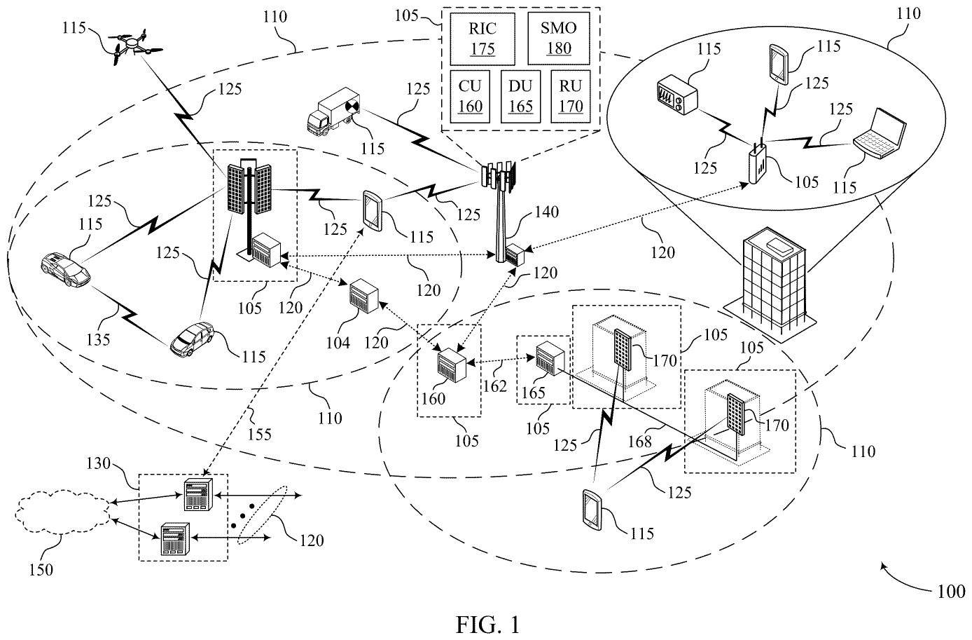

FIG. 1 shows an example of a wireless communications system 100 that supports puncturing and postponement of uplink transmissions with OCC in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (VIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support puncturing and postponement of uplink transmissions with OCC as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Afmax may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a network entity 105 may communicate with one or more UEs 115 via an NB-IoT link (e.g., a communication link 125 may be an NB-IoT link and the one or more UEs 115 may be NB-IoT devices). In NB-IoT, a UE 115 transmit multiple coded copies of data (e.g., repetitions of data) in an uplink transmission to increase the decoding accuracy at the network entity 105 (e.g., due to low signal to interference and noise ratio (SINR) conditions of NB-IoT uplink transmissions). In some examples, in NB-IoT, the network entity 105 may configure UEs 115 to use OCC for uplink transmissions to enable orthogonal M order UE multiplexing (e.g., multiplexing uplink transmissions from M different UEs on the same time-frequency resources). For example, application of an OCC may enable the transmissions from the multiple UEs via the same time-frequency resources to be orthogonal. Use of OCC may involve application of an M length OCC codeword across repetitions of data. For example, the network entity 105 may indicate to each UE 115 to be multiplexed a particular OCC codeword to apply to the repetitions of the uplink transmission for the particular UE 115. Thus, if the channel coding rate of the UEs 115 is sufficiently low for a given quantity of scheduled repetitions of data (e.g., communications via an NB-IoT link may be subject to noisy channel conditions that demand multiple repetitions), the UEs 115 may apply the M factor OCC without increasing the amount of time-frequency resources used for the uplink transmissions.

NB0IoT may co-exist with NR. In some examples, resources (e.g., time-frequency resources) for NB-IoT may overlap with NR. In some examples, for uplink NB-IoT (e.g., for NPUSCH), a solution to overlapping NB-IoT and NR resource may be to either postpone the NPUSCH or drop (e.g., not transmit or puncture) some NPUSCH units. As described herein, however, dropping such portions of a repetition of a transmission coded in accordance with an OCC configuration due to a scheduling conflict may result in the network being unable to combine and successfully decode the multiple repetitions. For example, dropping and/or postponing a portion of a repetition may impact the orthogonality of a transmission, which may lead to performance degradation of OCCs.

Accordingly, portions of NB-IoT uplink transmissions may be dropped or punctured based on scheduling conflicts. Such scheduling conflicts for both 3.75 kHz and 15 kHz SCS may include: resources configured for SRSs when the higher layer parameter npusch-allSymbols is set to false. As another example, such scheduling conflicts may include if there is an overlap (of reserved symbols for NR with NPUSCH symbols) of less than 1 ms (1 subframe) between a slot for 3.75 kHz SCS or a subframe for 15 kHz SCS. 1 ms equals 14 symbols of 15 kHz SCS, so up to 13 symbols may be punctured for 15 kHz SCS based on an overlap with a resource reserved for NR. 1 ms equals 3.5 symbols of 3.75 kHz SCS, so up to 3.5 symbols may be punctured for 3.75 kHz SCS based on an overlap with a resource reserved for NR. As another example, such a scheduling conflict may be based on a pre-compensation gap associated with segmented pre-compensation for communicating with NTNs for a UE 115, which may be based on a UE capability. For example, a pre-compensation gap may result in dropping of a slot or a symbol for an NPUSCH. In some examples, for a UE 115 communicating over NTN, a pre-compensation gap may be an amount of time units counted for NPUSCH resource mapping but not used for transmission of an NPUSCH after transmissions (and/or postponements due to NB-IoT physical random access channel (NPRACH)) of

$${N}_{segment}^{p recompensation}$$

time units for frame structure type 1, where the quantity

$${N}_{segment}^{p recompensation}$$

may be provided by higher layer signaling (e.g., RRC) based on the UE capability. The pre-compensation gap may be configured via the higher layer UE capability parameter ntn-SegmentedPrecompensationGaps-r17.

In some examples, the network entity 105 may provide signaling (e.g., higher layer signaling such as RRC) that indicates the resources reserved for SRS transmissions, NR communications, and/or pre-compensation gaps. The UE 115 and/or the network entity 105 may determine which resources indicated in an uplink grant for an NB-IoT uplink transmission conflict with (e.g., overlap with) the resources reserved for SRS transmissions, NR communications, and/or pre-compensation gaps. Dropping such portions of a repetition of a transmission coded in accordance with an OCC configuration due to a scheduling conflict, however, may result in the network entity 105 being unable to combine and successfully decode the multiple repetitions. For example, for the network entity 105 to successfully decode an uplink transmission encoded using OCC, the network entity 105 may combine the M repetitions to which the OCC codeword is applied. Accordingly, if some of the repetitions are missing all or portions of the data, the network entity 105 may not be able to successfully decode the uplink transmission.

In some examples, a UE 115 and a network entity 105 may determine whether to puncture resources within one or more repetitions of an uplink transmission scheduled for performance in accordance with an OCC configuration or whether to postpone the one or more repetitions of an uplink transmission based on whether the quantity of resources that would be punctured exceeds a threshold. The resources that would be punctured may be resources that are associated with a scheduling conflict, such as resources scheduled for SRS transmissions, resources reserved for NR communications, and/or resources associated with a pre-compensation gap associated with segmented pre-compensation for communicating with NTNs for the UE 115. For example, if the quantity of resources that would be punctured are smaller than the threshold, the network entity 105 may be able to combine and successfully decode the multiple repetitions even though some of the resources are punctured. If the quantity of resources that would be punctured is large enough that the network entity 105 would not be able to combine and successfully decode the multiple repetitions, the UE 115 and/or the network entity 105 may postpone at least the repetition that would be punctured to a later time resource (e.g., slot) that does not involve a scheduling conflict. In some examples, whether to puncture the resources or whether to postpone the one or more repetitions of an uplink transmission may be based on whether one or more DMRSs are scheduled within the resources that would be punctured due to the scheduling conflict. For example, dropping scheduled DMRSs may be costly in OCC-based systems, as the DMRSs may themselves be OCC-ed and may occur more sparsely than data. Loss of a DMRS may result in a loss of the ability of the network entity to estimate/determine the de-OCC-ed channels, which may reduce or eliminate the ability of the network entity 105 to decode the corresponding OCC-ed data segment.

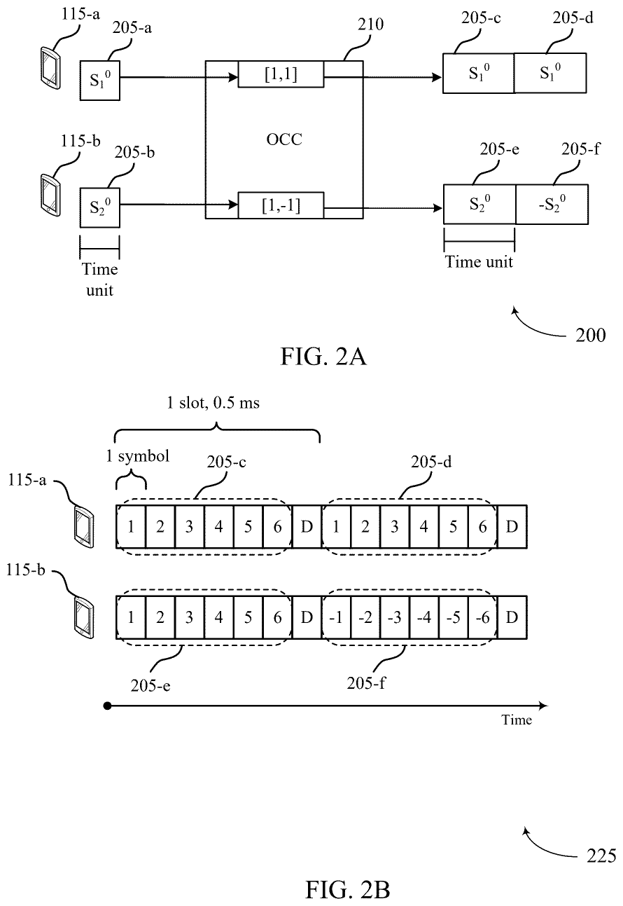

FIG. 2A shows an example of an OCC encoding diagram 200 that supports puncturing and postponement of uplink transmissions with OCC in accordance with one or more aspects of the present disclosure. FIG. 2B shows an example of a resource diagram 225 that supports puncturing and postponement of uplink transmissions with OCC in accordance with one or more aspects of the present disclosure. The OCC encoding diagram 200 and the resource diagram 225 may implement or may be implemented by aspects of the wireless communications system 100. For example, the OCC encoding diagram 200 and the resource diagram 225 may include a UE 115-a and a UE 115-b, which may be examples of UEs 115 as described herein.

As described herein, uplink transmissions (e.g., NPUSCH transmissions) from multiple UEs 115 may be multiplexed using OCC without sacrificing resource efficiency due to repetition. For example, OCC may be used to increase capacity (e.g., uplink transmissions from multiple UEs 115 may be packed into a same amount of time-frequency resources). Multiplexing multiple UEs 115 may cause interference at the receiving network entity 105. Such interference may be mitigated via the application of OCC at the transmitting UEs 115. For example, the data from the multiple UEs 115 may be cover coded across repetitions in an orthogonal manner using an OCC. As uplink transmissions in NB-IoT may be scheduled for repetition due to noisy channel conditions, OCC may be applied to already scheduled repetitions of data, thereby allowing for multiplexing without increasing the amount of time-frequency resources used for the uplink transmissions. OCC may allow for M order multiplexing of UEs, where Mis the quantity of UEs to be multiplexed. Accordingly, to multiplex M UEs, at least an M length OCC codeword may be applied to M repetitions of the data.

In the encoding configuration shown in the OCC encoding diagram 200, the UE 115-a may input a first encoded data time unit 205-a (e.g., an encoded slot or an encoded symbol) to an OCC matrix 210 and the UE 115-b may input a second encoded data time unit 205-b to the OCC matrix 210. The OCC matrix 210 may be a 2×2 matrix (e.g., two rows and two columns). For example, the OCC matrix 210 may be a Hadamard matrix, an identity matrix, or a DFT matrix. In OCC, each row or column of the OCC matrix 210 may be used as a codeword. To be compatible with OCC, each row or column of a matrix may be orthogonal.

For example, for the OCC matrix 210, the first row may correspond to a vector [1,1] that, when given as an input the first encoded data time unit 205-a, outputs a product including a third encoded data time unit 205-c and a fourth encoded data time unit 205-d. The third encoded data time unit 205-c and the fourth encoded data time unit 205-d may have the same values as the input of the first encoded data time unit 205-a since the vector is [1,1]. The second row of the matrix may correspond to a vector of [1, −1]. The second row, when given as an input the second encoded data time unit 205-b, outputs a product including a fifth encoded data time unit 205-e and a sixth encoded data time unit 205-f. The sixth encoded data time unit 205-f is a negative output of the input since a negative integer is applied in the vector of the matrix (e.g., the applied vector is [1, −1]). Applying the matrix in this manner to the input time units (e.g., encoded symbols or encoded slots), produces orthogonal outputs, and accordingly, transmissions from the UE 115-a and the UE 115-b are orthogonal and therefore do not interfere with each other. The encoding using the OCC matrix 210 may be applied to a set of time units for each UE (e.g., time unit Sₖⁱ, in which the data time is k at UE i).

In some examples, for four UEs 115, the matrix may be a 4×4 Hadamard matrix having four rows and four columns. In such examples, the matrix may include a first row vector of [1, 1, 1, 1], a second row vector of [1, −1, 1, −1], a third row vector [1, 1, −1, −1], and a fourth row vector [1, −1, −1, 1]. As described herein, although an OCC matrix 210 with row vectors [1,1] and [1, −1] is used as an example for multiplexing two UEs 115 and an OCC matrix with row vectors of [1, 1, 1, 1], [1, −1, 1, −1], [1, 1, −1, −1], and [1, −1, −1, 1] is used as an example for multiplexing four UEs 115, any orthogonal matrix may be used as an OCC matrix for multiplexing UEs 115. For example, any orthogonal 2×2 matrix may be used to multiplex two UEs 115 in OCC, any orthogonal 3×3 matrix may be used to multiplex three UEs 115 in OCC, any orthogonal 4×4 matrix may be used to multiplex four UEs 115 in OCC, and so on.

Accordingly, the OCC encoding diagram 200 may be used to implement TD symbol-wise OCC (where the time unit is a symbol) or TD slot wise OCC (where the time unit is a slot). OCC for NPUSCH may be used for NB-IoT NTN for multiple use cases. For example, symbol-level OCC (e.g., where each encoded time unit 205 is an OFDM symbol) may be applied for 3.75 kHz SCS for single carrier NPUSCH for UEs in the RRC connected mode. As another example, slot level OCC (e.g., where each encoded time unit 205 is a slot (such as seven OFDM symbols)) for 15 kHz single carrier NPUSCH transmissions.

The resource diagram 225 shows an example of slot-wise OCC (e.g., where each where each encoded time unit 205 is a slot of seven symbols). For example, for slot wise OCC, data symbols in a slot may be scaled by the respective OCC codeword at each UE 115. For example, the UE 115-a may apply the codeword [1,1] to the first encoded data time unit 205-a (e.g., an encoded slot), which becomes two encoded data time units 205 (e.g., two encoded slots), the third encoded data time unit 205-c and the fourth encoded data time unit 205-d. Similarly, the UE 115-b may apply the codeword [1, −1] to the second encoded data time unit 205-b (e.g., an encoded slot), which becomes two encoded data time units 205 (e.g., two encoded slots), the fifth encoded data time unit 205-e and the sixth encoded data time unit 205-f. At the receiving network entity 105, the network entity 105 may buffer the two slots (e.g., where M=2 as in the resource diagram 225) and may perform a dot product with the respective codeword to obtain the data symbols for each UE 115. The same concept may be applied to symbol-wise OCC (e.g., at the granularity of an OFDM symbol) instead of slot-wise OCC. For example, symbol wise OCC may be applied for single tone 3.75 SCS NPUSCH with an OCC factor of 2 (e.g., M=2) as described herein.

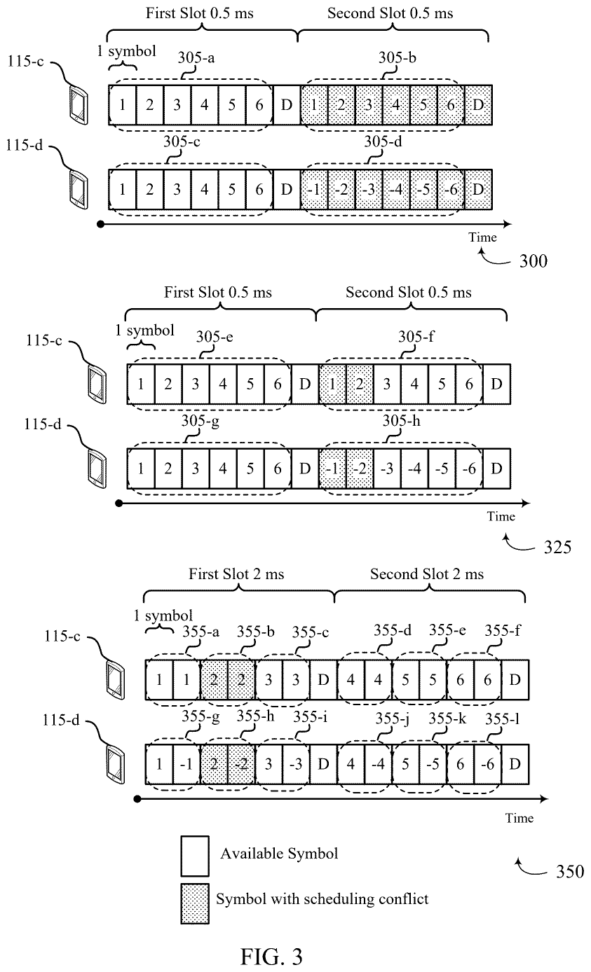

FIG. 3 shows an example of a resource diagram 300, a resource diagram 325, and a resource diagram 350 that supports puncturing and postponement of uplink transmissions with OCC in accordance with one or more aspects of the present disclosure. The resource diagram 300, the resource diagram 325, and the resource diagram 350 may implement or may be implemented by aspects of the wireless communications system 100. For example, the resource diagram 300, the resource diagram 325, and the resource diagram 350 may include a UE 115-c and a UE 115-d, which may be examples of UEs 115 as described herein.

The resource diagram 300 shows an example where slot-wise OCC is applied by the UE 115-c and the UE 115-d operating in 15 kHz SCS. For example, the UE 115-c may apply a first OCC codeword to a first data repetition 305-a in a first slot and a second data repetition 305-b in a second slot, and each slot may be 0.5 ms. Similarly, the UE 115-d may apply a second OCC codeword orthogonal to the first OCC codeword applied by the UE 115-c to a first data repetition 305-c in the first slot and a second data repetition 305-d in the second slot. In some examples, a 0.5 ms chunk of time (e.g., the second slot) may be unavailable and accordingly dropped. In some examples, the second slot may be unavailable due to co-existence with NR. For example, the UEs 115 may receive a subframe-level bitmap via higher layer signaling that may indicate slots reserved for NR by a network entity 105 (e.g., an eNB). For example, Table 1 indicates an example of codes in a subframe level bitmap which may indicate whether slots and symbols are available for NPUSCH, where 1 subframe=1 ms=2 slots for 15 kHz SCS NB-IoT.

TABLE 1

| Bitmap in | | |
|---|---|---|
| a subframe | Slot-level granularity | Symbol-level granularity |
| 00 | Both slots can be used | Both slots can be used |
| 01 | 2^{nd} slot is reserved | Indicated by a second bitmap |
| 10 | 1^{st} slot is reserved | Indicated by a third bitmap |
| 11 | Both slots are reserved | Both slots are reserved |

As another example, the second slot may be unavailable to the UEs 115 due to a pre-compensation gap (e.g., a pre-compensation gap of 0.5 ms), which may result in the UEs 115 dropping a slot for 15 kHz SCS.

When the UEs 115 drop the data repetitions 305 in the second slot (e.g., when the UE 115-c drops the second data repetition 305-b and the UE 115-d drops the second data repetition 305-d), the transmissions by the UE 115-c and the UE 115-d may not be orthogonal. For example, the first data repetition 305-a may not be orthogonal with the first data repetition 305-c absent the second data repetition 305-b and the second data repetition 305-d, and accordingly data in the symbols of the first data repetition 305-a and the first data repetition 305-c may be undecodable at the network entity 105, which may result in performance or capacity loss.

The resource diagram 325 shows an example where slot-wise OCC is applied by the UE 115-c and the UE 115-d operating in 15 kHz SCS. For example, the UE 115-c may apply a first OCC codeword to a first data repetition 305-e in a first slot and a second data repetition 305-f in a second slot, and each slot may be 0.5 ms. Similarly, the UE 115-d may apply a second OCC codeword orthogonal to the first OCC codeword applied by the UE 115-c to a first data repetition 305-g in the first slot and a second data repetition 305-h in the second slot. In some examples, several symbols (e.g., symbols 1 and 2) of the second slot may be unavailable and accordingly dropped. For example, symbols within a slot may be dropped when SRS(s) are configured within the symbols and the higher layer parameter npusch-allsymbols is set to false.

In the case shown in the resource diagram 325, the receiving network entity 105 may be unable to decode symbols 1 and 2 as the orthogonal counterparts were lost in the second symbol due to the dropping/puncturing. The network entity 105 may still be able to decode symbols 3, 4, 5, and 5 because the orthogonality of those symbols was maintained via the transmission of those symbols in the first data repetition 305-e in the first slot and the second data repetition 305-f in the second slot for the UE 115-c and the first data repetition 305-g in the first slot and the second data repetition 305-h in the second slot for the UE 115-d.

The resource diagram 350 shows an example where symbol-wise OCC is applied for 3.75 kHz SCS single tone. For example, the UE 115-c may apply a first OCC codeword to data repeated across a first set of two symbols 355-a, data repeated across a second set of two symbols 355-b, and data repeated across a third set of two symbols 355-c within a first 2 ms slot. The UE 115-c may apply the first OCC codeword to data repeated across a fourth set of two symbols 355-d, data repeated across a fifth set of two symbols 355-e, and data repeated across a sixth set of two symbols 355-f within a second 2 ms slot. Similarly, the UE 115-d may apply a second OCC codeword orthogonal to the first OCC codeword applied by the UE 115-c to data repeated across a first set of two symbols 355-g, data repeated across a second set of two symbols 355-h, and data repeated across a third set of two symbols 355-i within a first 2 ms slot. The UE 115-d may apply the second OCC codeword orthogonal to the first codeword applied by the UE 115-c to data repeated across a fourth set of two symbols 355-j, data repeated across a fifth set of two symbols 355-k, and data repeated across a sixth set of two symbols 355-1 within a second 2 ms slot.

In some examples, a 0.5 ms chunk of time may be unavailable, and accordingly may be dropped or punctured. For example, the 0.5 ms chunk of time may be unavailable due to co-existence with NR or a pre-compensation gap. For example, as described herein, the UEs 115 may receive a subframe-level bitmap via higher layer signaling that may indicate slots reserved for NR by a network entity 105 (e.g., an eNB). In 3.75 kHz SCS, 0.5 ms corresponds to approximately 1.75 symbols. Accordingly, two symbols may be unavailable as shown in the resource diagram 350.

In the case shown in the resource diagram 350, the receiving network entity 105 may be unable to decode symbol 2 as both OCC copies are dropped by both the UE 115-c and the UE 115-d. The network entity 105 may be able to decode the remainder of the symbols successfully (e.g., symbols 1, 3, 4, 5, and 6) as the network entity 105 is able to receive both copies of each symbol from each of the UE 115-c and the UE 115-d.

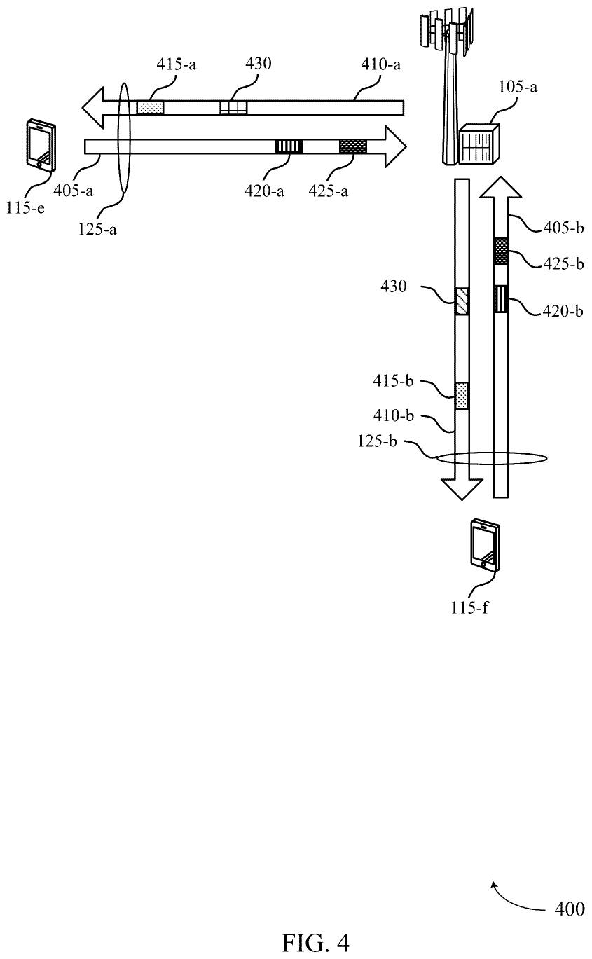

FIG. 4 shows an example of a wireless communications system 400 that supports puncturing and postponement of uplink transmissions with OCC in accordance with one or more aspects of the present disclosure. The wireless communications system 400 may implement aspects of or may be implemented by aspects of the wireless communications system 100. For example, the wireless communications system 400 includes a UE 115-e and a UE 115-f, which may be examples of a UE 115 described with respect to FIG. 1. The wireless communications system 400 also includes a network entity 105-a, which may be an example of a network entity 105 as described with respect to FIG. 1.

The UE 115-e may communicate with the network entity 105-a using a communication link 125-a, and the UE 115-f may communicate with the network entity 105-a using a communication link 125-b. In some examples, the communication link 125-a may be an example of an NB-IoT link between the UE 115-e and the network entity 105-a. In some examples, the communication link 125-b may be an example of an NB-IoT link between the UE 115-f and the network entity 105-b. In some examples, the communication link 125-a and/or the communication link 125-b may be examples of an NTN link. The communication link 125-a and the communication link 125-b may include bi-directional links that enable both uplink and downlink communications. For example, the UE 115-e may transmit the uplink signals 405-a (e.g., uplink transmissions), such as uplink control signals or uplink data signals, to the network entity 105-a using the communication link 125-a and the network entity 105-a may transmit downlink signals 410-a (e.g., downlink transmissions), such as downlink control signals or downlink data signals, to the UE 115-e using the communication link 125-a. The UE 115-f may transmit uplink signals 405-b (e.g., uplink transmissions), such as uplink control signals or uplink data signals, to the network entity 105-a using the communication link 125-b and the network entity 105-a may transmit downlink signals 410-b (e.g., downlink transmissions), such as downlink control signals or downlink data signals, to the UE 115-f using the communication link 125-b.

The network entity 105-a may transmit control signaling 415-a to the UE 115-e that indicates first scheduling information for a set of repetitions of a first uplink transmission 420-a. For example, the control signaling 415-a may be a downlink control information (DCI) message (e.g., the first uplink transmission 420-a may be a dynamically granted NPUSCH). The first scheduling information in the control signaling 415-a may indicate a first set of resources for the set of repetitions of the first uplink transmission 420-a. The first scheduling information may indicate to perform the set of repetitions of the first uplink transmission 420-a in accordance with a first OCC configuration. For example, the OCC configuration may indicate a multiplexing order M and/or a first OCC codeword to apply to the set of repetitions. Similarly, the network entity 105-a may transmit control signaling 415-b to the UE 115-f that indicates second scheduling information for a set of repetitions of a second uplink transmission 420-b. For example, the control signaling 415-b may be a DCI message (e.g., the second uplink transmission 420-b may be a dynamically granted NPUSCH). The second scheduling information in the control signaling 415-b may indicate the first set of resources for the set of repetitions of the second uplink transmission 420-b (e.g., the same time-frequency resources as the first uplink transmission 420-a). The second scheduling information may indicate to perform the set of repetitions of the first uplink transmission 420-a in accordance with a second OCC configuration. For example, the second OCC configuration may indicate the multiplexing order M and/or a second OCC codeword to apply to the set of repetitions. The application of the first OCC codeword to the set of repetitions of the first uplink transmission 420-a and the application of the OCC codeword to the set of repetitions of the second uplink transmission 420-b may result in the first uplink transmission 420-a being orthogonal to the second uplink transmission 420-b from the perspective of the network entity 105-a.

In some examples, the UE 115-e may transmit capability signaling 425-a to the network entity 105-a that indicates the UE 115-e supports OCC based multiplexing. Similarly, the UE 115-f may transmit capability signaling 425-b to the network entity 105-a that indicates the UE 115-e supports OCC based multiplexing. For example, the capability for OCC based multiplexing may be based on the phase coherence capabilities associated with the UEs 115. Transmission of the control signaling 415-a may be based on the capability signaling 425-a, and transmission of the control signaling 415-b may be based on the capability signaling 425-b. For example, the network entity 105-a may schedule the UE 115-e and the UE 115-a to perform OCC based multiplexing of the uplink transmissions 420 based on the indications in the capability signaling 425-a and the capability signaling 425-b that the UE 115-e and the UE 115-f support OCC based multiplexing.

In some examples, as described herein, a scheduling conflict may exist for at least a subset of resources of the first set of resources (e.g., some slots or symbols of the first set of resources may be unavailable for the uplink transmissions 420 due to the scheduling conflict). For example, the scheduling conflict may be due to the at least the subset of resources being scheduled for SRS transmissions, being resources reserved for NR communications, and/or being resources associated with a pre-compensation gap associated with segmented pre-compensation for communicating with NTNs for the UEs 115. In some examples, the network entity 105-a may transmit control signaling 425 (e.g., RRC signaling) that may indicate such resources reserved for SRS transmissions, NR communications, and/or pre-compensation gaps. For example, the control signaling 425 may include one or more bitmaps that indicate resources reserved for SRS transmissions, NR communications, and/or pre-compensation gaps (e.g., that indicates resources that are unavailable).

In some examples, the UE 115-e may perform the set of repetitions of the first uplink transmission 420-a in accordance with the first OCC configuration via the first set of resources or via a second set of resources based on whether the at least the subset of resources of the first set of resources associated with a scheduling conflict exceeds a threshold quantity of resources, where at least a portion of the second set of resources is subsequent in time to the first set of resources indicated by the first scheduling information. For example, the UE 115-e may perform the set of repetitions of the first uplink transmission 420-a via the first set of resources if the at least the subset of resources are less than or equal to the threshold quantity of resources, and the UE 115-e may puncture or drop the respective portions of the set of repetitions of the first uplink transmission 420-a scheduled in the at least the subset of resources. As another example, the UE 115-e may perform the set of repetitions of the first uplink transmission 420-a via the second set of resources (e.g., may at least partially postpone the first uplink transmission 420-a) if the at least the subset of resources exceeds the threshold quantity of resources. Similarly, the UE 115-f may perform the set of repetitions of the second uplink transmission 420-b in accordance with the second OCC configuration via the first set of resources or via the second set of resources based on whether the at least the subset of resources of the first set of resources associated with a scheduling conflict exceeds the threshold quantity of resources. For example, the UE 115-f may perform the set of repetitions of the second uplink transmission 420-b via the first set of resources if the at least the subset of resources are less than or equal to the threshold quantity of resources, and the UE 115-f may puncture or drop the respective portions of the set of repetitions of the second uplink transmission 420-b scheduled in the at least the subset of resources. As another example, the UE 115-e may perform the set of repetitions of the second uplink transmission 420-b via the second set of resources (e.g., may at least partially postpone the second uplink transmission 420-b) if the at least the subset of resources exceeds the threshold quantity of resources.

For example, for a multiplexing order M, each UE 115 (e.g., the UE 115-e and the UE 115-f) and/or the network entity 105-a may examine M consecutive repetition time units, where a repetition time unit may be a slot or symbol depending on whether slot-wise or symbol-wise OCC is applied. M consecutive repetition time units may be referred to as a chunk. Each UE 115 and/or the network entity 105-a may calculate or determine subset of resources within the chunk (e.g., the resources within the chunk to be dropped or punctured based on a scheduling conflict). For example, the at least the subset of resources may be a quantity of symbols to be dropped or punctured.

If the quantity of resources to be dropped or punctured (e.g., the at least the subset of resources) within the chunk is less than or equal a threshold quantity of resources, the UEs 115 may drop or puncture the portions of the uplink transmissions 420 scheduled within the resources to be dropped or punctured. For example, the UEs 115 may accept the drop in performance caused by dropping/puncturing the portions of the uplink transmissions 420 scheduled within the resources to be dropped or punctured.

If the quantity of resources to be dropped or punctured (e.g., the at least the subset of resources) within the chunk is greater than the threshold, the UEs 115 may postpone at least a portion of the chunk. In some examples, the UEs 115 may postpone a portion of the chunk (e.g., if one slot is unavailable, the UEs 115 may postpone one slot). In some examples, the UEs 115 may postpone the entire chunk (e.g., of M consecutive time units) until a next available chunk (e.g., of M consecutive time units). If the UEs 115 postpone at least a portion of the chunk, the UEs 115 may accept the hit to the latency of the uplink transmissions 420.

In some examples, the threshold quantity of resources may be a function of the OCC factor M, the SCS, the OCC scheme (e.g., whether slot-wise or symbol-wise OCC is used), or a combination thereof. In some examples, the threshold quantity of resources may be pre-defined or standardized. In some examples, the threshold quantity of resources may be signaled by the network entity 105-a to the UEs 115 (e.g., via the control signaling 415 and/or via additional control signaling 430).

Dropping/puncturing portions of uplink transmissions 420 or postponing at least portions of uplink transmissions 420 may result in increased overall latency of the NB-IoT system due to postponement and/or in loss of performance due to puncturing/dropping. Use of the threshold, however, may avoid scenarios where the orthogonality of OCC is destroyed (e.g., which may lead to complete re-transmission and higher latency).

In some examples, dropping/puncturing portions of uplink transmissions 420 or postponing at least portions of uplink transmissions 420 may be based on whether one or more DMRSs are scheduled within the resources that would be punctured due to the scheduling conflict. For example, the control signaling 415-a may indicate which symbol(s) of the first uplink transmission 420-a are scheduled to include DMRSs and the control signaling 415-b may indicate which symbol(s) of the second uplink transmission 420-b are scheduled to include DMRSs. The DMRSs in the first uplink transmission 420-a and the second uplink transmission 420-b may be OCC-ed in accordance with the first OCC configuration and the second OCC configuration, respectively. The network entity 105-a may de-OCC the DMRSs in the first uplink transmission 420-a and the second uplink transmission 420-b, and may use the de-OCC-ed DMRSs in the first uplink transmission 420-a and the second uplink transmission 420-b to estimate the channels between the network entity 105-a and the UE 115-e and the network entity 105-a and the UE 115-f. Loss of a DMRS may result in a loss of the ability of the network entity 105-a to estimate/determine the de-OCC-ed channels, which may reduce or eliminate the ability of the network entity to decode the corresponding portions of the uplink transmissions 420. Accordingly, in some examples, the UE 115-e may postpone at least a portion of the first uplink transmission 420-a if the portion of the uplink transmission is associated with a scheduling conflict and includes one or more resources scheduled for DMRS transmission. In some such examples, the UE 115-e may puncture/drop at least a portion of the first uplink transmission 420-a if the portion of the uplink transmission is associated with a scheduling conflict and does not include one or more resources scheduled for DMRS transmission. Similarly, in some examples, the UE 115-f may postpone at least a portion of the second uplink transmission 420-b if the portion of the uplink transmission is associated with a scheduling conflict and includes one or more resources scheduled for DMRS transmission. In some such examples, the UE 115-f may puncture/drop at least a portion of the second uplink transmission 420-b if the portion of the uplink transmission is associated with a scheduling conflict and does not include one or more resources scheduled for DMRS transmission.

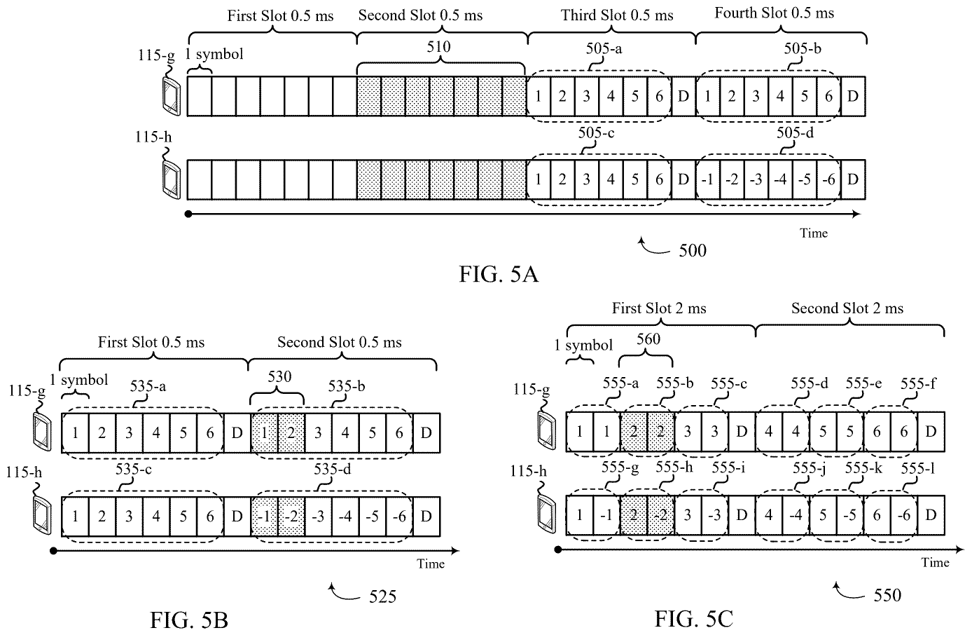

FIG. 5A shows an example of a resource diagram 500 that supports puncturing and postponement of uplink transmissions with OCC in accordance with one or more aspects of the present disclosure. FIG. 5B shows an example of a resource diagram 525 that supports puncturing and postponement of uplink transmissions with OCC in accordance with one or more aspects of the present disclosure. FIG. 5C shows an example of a resource diagram 550 that supports puncturing and postponement of uplink transmissions with OCC in accordance with one or more aspects of the present disclosure. The resource diagram 500, the resource diagram 525, and the resource diagram 550 may implement or may be implemented by aspects of the wireless communications system 100 or the wireless communications system 400. For example, the resource diagram 500, the resource diagram 525, and the resource diagram 550 may include a UE 115-g and a UE 115-h, which may be examples of UEs 115 as described herein.

The resource diagram 500 shows an example where slot-wise OCC is applied by the UE 115-g and the UE 115-h operating in 15 kHz SCS. For example, the UE 115-g may be scheduled (e.g., via a DCI) to apply a first OCC codeword to a first data repetition in a first slot and a second data repetition in a second slot, and each slot may be 0.5 ms. Similarly, the UE 115-h may be scheduled (e.g., via a DCI) to apply a second OCC codeword orthogonal to the first codeword applied by the UE 115-g to a first data repetition in the first slot and a second data repetition in the second slot. In the example of the resource diagram 500, a 0.5 ms chunk of time 510 (e.g., the second slot) may be unavailable due to a scheduling conflict. For example, the UEs 115 may receive a subframe-level bitmap via higher layer signaling that may indicate slots reserved for NR by a network entity 105 (e.g., an eNB). As another example, the 0.5 ms chunk of time 510 may be unavailable to the UEs 115 due to a pre-compensation gap (e.g., a pre-compensation gap of 0.5 ms), which may result in the UEs 115 dropping a slot for 15 kHz SCS.

As slot-wise OCC is applied in the resource diagram 500, the UEs 115 may examine M consecutive slots (e.g., as a slot is the OCC repetition unit in slot-wise OCC). Where M equals 2, the UEs 115 may examine the two scheduled slots (the first slot and the second slot), and determine the resources to be punctured/dropped within the first two slots based on the scheduling conflict. In the resource diagram 500, 7 symbols are to be dropped/punctured due to the scheduling conflict (e.g., the 7 symbols of the second slot are the 0.5 ms chunk of time 510 unavailable to the UEs 115). The UEs 115 may compare the quantity of resources to a threshold quantity of resources. For example, the threshold quantity of resources may be 6 symbols. As 7 symbols (the quantity to be dropped/punctured) is greater than 6 symbols (the threshold quantity of resources), the UEs 115 and the network entity 105 may postpone the transmission of the chunk (of M consecutive slots) to the next available chunk (of M consecutive slots). For example, as shown in the resource diagram 500, the UE 115-g may apply the first OCC codeword to a first data repetition 505-a in the third slot and a second data repetition 505-b in the fourth slot. Similarly, the UE 115-h may apply the second OCC codeword to a first data repetition 505-c in the third slot and a second data repetition 505-d in the fourth slot.

The resource diagram 525 shows an example where slot-wise OCC is applied by the UE 115-g and the UE 115-h operating in 15 kHz SCS. For example, the UE 115-g may be scheduled (e.g., via a DCI) to apply a first OCC codeword to a first data repetition in a first slot and a second data repetition in a second slot, and each slot may be 0.5 ms. Similarly, the UE 115-h may be scheduled (e.g., via a DCI) to apply a second OCC codeword orthogonal to the first codeword applied by the UE 115-g to a first data repetition in the first slot and a second data repetition in the second slot. In the example of the resource diagram 525, several symbols 530 may be unavailable due to a scheduling conflict. For example, symbols 1 and 2 within the second slot may be unavailable when SRS(s) are configured within the symbols and the higher layer parameter npusch-allsymbols is set to false and/or due to a pre-compensation gap.

As slot-wise OCC is applied in the resource diagram 525, the UEs 115 may examine M consecutive slots (e.g., as a slot is the OCC repetition unit in slot-wise OCC). Where M equals 2, the UEs 115 may examine the two scheduled slots (the first slot and the second slot), and determine the resources to be punctured/dropped within the first two slots based on the scheduling conflict. In the resource diagram 525, 2 symbols are to be dropped/punctured due to the scheduling conflict (e.g., symbols 1 and 2 of the second slot). The UEs 115 may compare the quantity of resources to a threshold quantity of resources. For example, the threshold quantity of resources may be 6 symbols. As 2 symbols (the quantity to be dropped/punctured) is less than 6 symbols (the threshold quantity of resources), the UEs 115 and the network entity 105 may puncture the unavailable symbols (e.g., and may experience a hit in performance due to the puncturing). For example, the as shown in the resource diagram 525, the UE 115-g may apply the first OCC codeword to a first data repetition 535-a in the first slot and a second data repetition 535-b in the second slot, but may puncture the first and second symbols of the second data repetition 535-b. Similarly, the UE 115-h may apply the second OCC codeword to a first data repetition 535-c in the first slot and a second data repetition 535-d in the second slot, but may puncture the first and second symbols of the second data repetition 535-d. Accordingly, the orthogonality of the first and second symbols of the uplink transmissions by the UE 115-g and the UE 115-h may be destroyed, but the network entity 105 may successfully decode symbols 3-6 of the uplink transmissions by the UE 115-g and the UE 115-h in the first and second slots.

The resource diagram 550 shows an example where symbol-wise OCC is applied for 3.75 kHz SCS single tone. For example, the UE 115-g may be scheduled (e.g., via DCI) to apply a first OCC codeword to data repeated across a first set of two symbols 555-a, data repeated across a second set of two symbols 555-b, and data repeated across a third set of two symbols 555-c within a first 2 ms slot. The UE 115-g may be scheduled (e.g., via DCI) to apply the first OCC codeword to data repeated across a fourth set of two symbols 555-d, data repeated across a fifth set of two symbols 555-e, and data repeated across a sixth set of two symbols 555-f within a second 2 ms slot. Similarly, the UE 115-h may be scheduled (e.g., via DCI) to apply a second OCC codeword orthogonal to the first codeword applied by the UE 115-g to data repeated across a first set of two symbols 555-g, data repeated across a second set of two symbols 555-h, and data repeated across a third set of two symbols 555-i within a first 2 ms slot. The UE 115-h may be scheduled (e.g., via DCI) to apply the second OCC codeword orthogonal to the first codeword applied by the UE 115-g to data repeated across a fourth set of two symbols 555-j, data repeated across a fifth set of two symbols 555-k, and data repeated across a sixth set of two symbols 555-1 within a second 2 ms slot. In some examples, a 0.5 ms chunk of time 560 may be unavailable, and accordingly may be dropped or punctured. For example, the 0.5 ms chunk of time 560 may be unavailable due to co-existence with NR or a pre-compensation gap.

As symbol-wise OCC is applied in the resource diagram 550, the UEs 115 may examine M consecutive symbols (e.g., as a symbol is the OCC repetition unit in symbol-wise OCC). Where M equals 2, the UEs 115 may examine each two sets of symbols, and determine the resources to be punctured/dropped within each two sets of symbols based on scheduling conflicts. In the resource diagram 550, 2 symbols in the first slot are to be dropped/punctured due to a scheduling conflict. The UEs 115 may compare the quantity of resources to a threshold quantity of resources. For example, the threshold quantity of resources may be 3 symbols. As 2 symbols (the quantity to be dropped/punctured) is less than 3 symbols (the threshold quantity of resources), the UEs 115 and the network entity 105 may puncture the unavailable symbols (e.g., and may experience a hit in performance due to the puncturing). For example, the UE 115-g may apply the first OCC codeword to data repeated across the first set of two symbols 555-a, data repeated across the third set of two symbols 555-c, the data repeated across the fourth set of two symbols 555-d, the data repeated across the fifth set of two symbols 555-e, and the data repeated across the sixth set of two symbols 555-f. The UE 115-g may drop or puncture the second set of two symbols 555-b. Similarly, the UE 115-h may apply the second OCC codeword to data repeated across the first set of two symbols 555-g, data repeated across the third set of two symbols 555-i, the data repeated across the fourth set of two symbols 555-j, the data repeated across the fifth set of two symbols 555-k, and the data repeated across the sixth set of two symbols 555-1. The UE 115-g may drop or puncture the second set of two symbols 555-h.

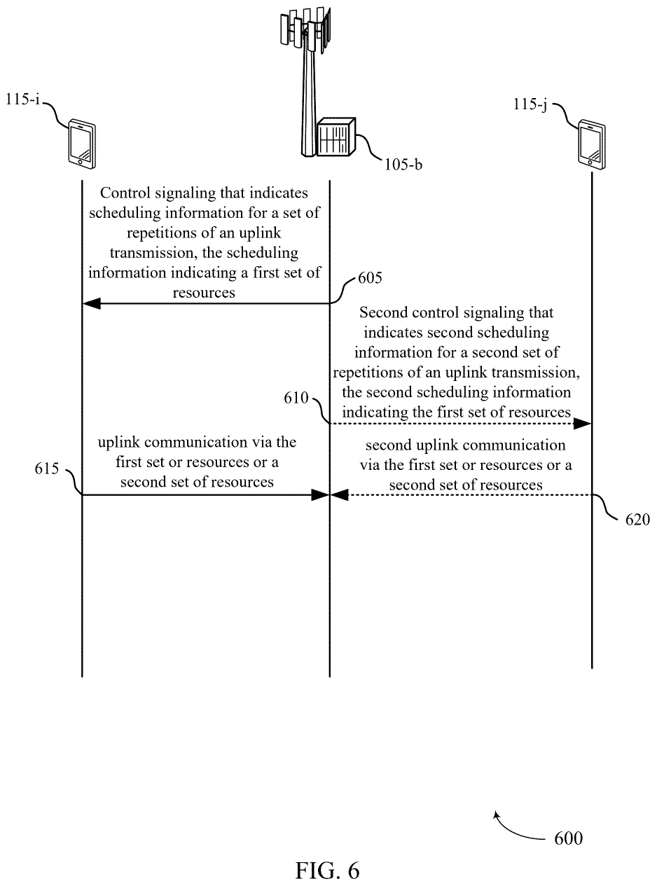

FIG. 6 shows an example of a process flow 600 that supports puncturing and postponement of uplink transmissions with OCC in accordance with one or more aspects of the present disclosure. The process flow 600 may involve two or more UEs 115, such as a UE 115-i and a UE 115-j, which may be examples of UEs 115, as described herein. The process flow 600 may also involve a network entity 105-b, which may be an example of network entity 105, as described with respect to FIG. 1.

In some examples, the operations illustrated in process flow 600 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 605, the network entity 105-b may transmit, and the UE 115-i may receive, control signaling that indicates scheduling information for a set of repetitions of an uplink transmission. For example, the control signaling may include a DCI message that indicates the scheduling information. In some examples, the uplink transmission may be an NPUSCH transmission. The scheduling information may indicate a first set of resources for the set of repetitions of the uplink transmission. The scheduling information may indicate to perform the set of repetitions of the uplink transmission in accordance with an OCC configuration.

In some examples, at 610, the network entity 105-b may transmit, and the UE 115-j may receive, second control signaling that indicates second scheduling information for a second set of repetitions of a second uplink transmission. For example, the second control signaling may include a DCI message that indicates the scheduling information. In some examples, the second uplink transmission may be an NPUSCH transmission. The second scheduling information may indicate the first set of resources for the second set of repetitions of the second uplink transmission (e.g., the uplink transmission and the second uplink transmission may be scheduled on the same set of time-frequency resources). The second scheduling information may indicate to perform the second set of repetitions of the second uplink transmission in accordance with a second OCC configuration. For example, the first OCC configuration may indicate a multiplexing order M and/or a first OCC codeword, and the second OCC configuration may indicate the multiplexing order M and/or a second OCC codeword.

At 615, the UE 115-i may perform, and the network entity 105-b may receive, the set of repetitions of the uplink transmission in accordance with the OCC configuration via the first set of resources or via a second set of resources based on whether at least a subset of resources of the first set of resources associated with a scheduling conflict exceeds a threshold quantity of resources and/or based on a presence or an absence of one or more scheduled DMRSs within the at least the subset of resources. At least a portion of the second set of resources may be subsequent in time to the first set of resources.

In some examples, at 620, the UE 115-j may perform, and the network entity 105-b may receive, the second set of repetitions of the second uplink transmission in accordance with the second OCC configuration via the first set of resources or via the second set of resources based on whether the at least the subset of resources exceeds the threshold quantity of resources.

In some examples, at 615, the UE 115-i may perform, and the network entity 105-b may receive, the set of repetitions of the uplink transmission via the first set of resources based on the at least the subset of resources being less than or equal to the threshold quantity of resources, and respective portions of the set of repetitions of the uplink transmission scheduled in the at least the subset of resources are dropped (e.g., punctured) in accordance with the scheduling conflict. In some such examples, at 620, the UE 115-j may perform, and the network entity 105-b may receive, the second set of repetitions of the second uplink transmission via the first set of resources based on the at least the subset of resources being less than or equal to the threshold quantity of resources, and respective portions of the second set of repetitions of the second uplink transmission scheduled in the at least the subset of resources are dropped (e.g., punctured) in accordance with the scheduling conflict.

In some examples, at 615, the UE 115-i may perform, and the network entity 105-b may receive, the set of repetitions of the uplink transmission via the second set of resources based on the at least the subset of resources being greater than the threshold quantity of resources. In some such examples, at 620, the UE 115-j may perform, and the network entity 105-b may receive, the second set of repetitions of the second uplink transmission via the second set of resources based on the at least the subset of resources being greater than the threshold quantity of resources. In some examples, a totality of the second set of resources is subsequent in time to the first set of resources. In some examples, a temporally first time resource of the first set of resources is the same as a temporally first time resource of the second set of resources, a temporally second time resource of the second set of resources is subsequent in time to a temporally second time resource of the first set of resources, and the temporally second time resource of the first set of resources includes one or more resources of the at least the subset of resources. For example, the UE 115-i may perform a first repetition in a first resource of the first set of time resources as originally scheduled by the scheduling information but may postpone a second repetition to a later resource than originally scheduled by the scheduling information due to the scheduling conflict.

In some examples, where the OCC configuration indicates the multiplexing order M and an OCC (e.g., an OCC codeword) to apply to the set of repetitions of the uplink transmission, and a total quantity of repetitions of the set of repetitions of the uplink transmission is greater than or equal to the multiplexing order. Similarly, the second OCC may indicate the multiplexing order and a second OCC (e.g., a second OCC codeword) to apply to the second set of repetitions of the second uplink transmission. For example, a repetition may refer to the unit of time-frequency resources to which a transport block is mapped. An M length codeword may be applied to the M repetitions (e.g., M transport blocks carrying the same data may be mapped to M time-frequency resources, and the M length codeword may be applied to the M time-frequency resources). Thus, the total quantity of units of time-frequency resources in an OCC uplink transmission may scale with M.

In some examples, the threshold quantity of resources may be based on an SCS associated with the set of repetitions of the uplink transmission, a time-domain granularity associated with the OCC configuration, a multiplexing order associated with the OCC configuration, or a combination thereof.

In some examples, the threshold quantity of resources may be a threshold quantity of symbols.

In some examples, the UE 115-i and/or the network entity 105-b may obtain an indication of a third set of resources associated with a second radio access technology (e.g., NR). In such examples, the set of repetitions of the uplink transmission may be associated with a first radio access technology (e.g., NB-IoT), and the scheduling conflict may be based on the at least the subset of resources being included within the third set of resources.

In some examples, the UE 115-i and/or the network entity 105-b may obtain an indication of a third set of resources associated with SRS transmission. In such examples, the scheduling conflict may be based on the at least the subset of resources being included within the third set of resources.

In some examples, the UE 115-i and/or the network entity 105-b may identify a third set of resources associated with a pre-compensation gap associated with segmented pre-compensation for communicating with NTNs for the UE 115-i. In such examples, the scheduling conflict may be based on the at least the subset of resources being included within the third set of resources.

In some examples, the UE 115-i may receive, from the network entity 105-b, via the control signaling or second control signaling, an indication of the threshold quantity of resources.

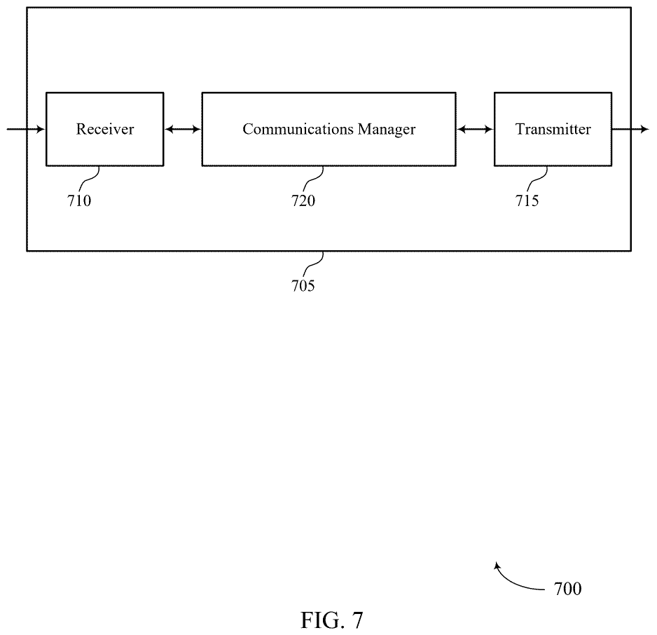

FIG. 7 shows a block diagram 700 of a device 705 that supports puncturing and postponement of uplink transmissions with OCC in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to puncturing and postponement of uplink transmissions with OCC). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to puncturing and postponement of uplink transmissions with OCC). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of puncturing and postponement of uplink transmissions with OCC as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The communications manager 720 is capable of, configured to, or operable to support a means for performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

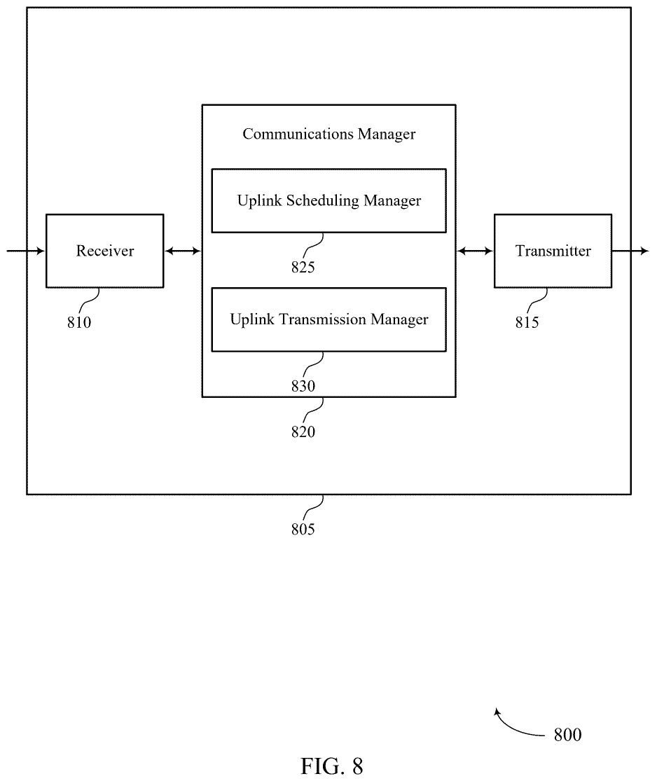

FIG. 8 shows a block diagram 800 of a device 805 that supports puncturing and postponement of uplink transmissions with OCC in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to puncturing and postponement of uplink transmissions with OCC). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to puncturing and postponement of uplink transmissions with OCC). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of puncturing and postponement of uplink transmissions with OCC as described herein. For example, the communications manager 820 may include an uplink scheduling manager 825 an uplink transmission manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The uplink scheduling manager 825 is capable of, configured to, or operable to support a means for receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The uplink transmission manager 830 is capable of, configured to, or operable to support a means for performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

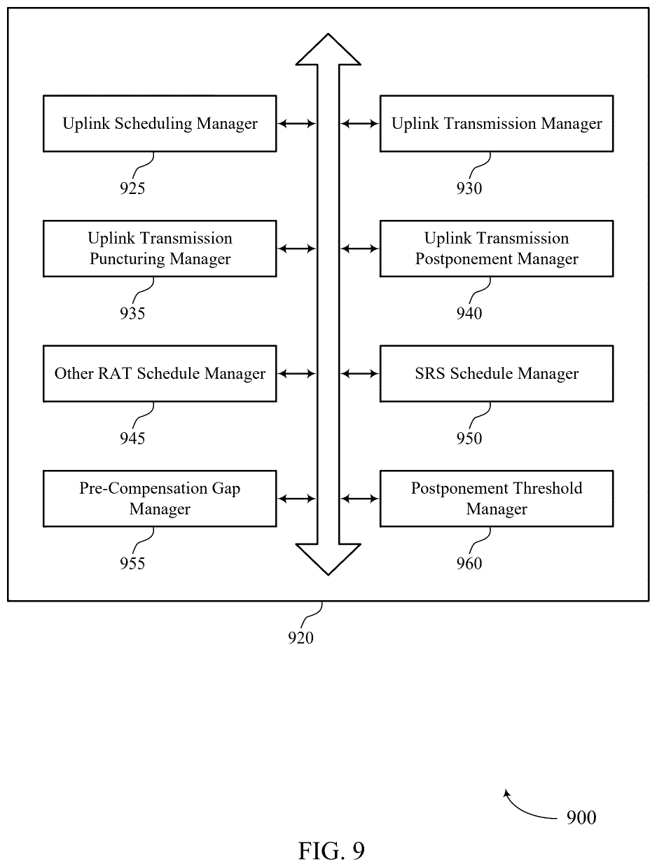

FIG. 9 shows a block diagram 900 of a communications manager 920 that supports puncturing and postponement of uplink transmissions with OCC in accordance with one or more aspects of the present disclosure. The communications manager 920 may be an example of aspects of a communications manager 720, a communications manager 820, or both, as described herein. The communications manager 920, or various components thereof, may be an example of means for performing various aspects of puncturing and postponement of uplink transmissions with OCC as described herein. For example, the communications manager 920 may include an uplink scheduling manager 925, an uplink transmission manager 930, an uplink transmission puncturing manager 935, an uplink transmission postponement manager 940, another RAT schedule manager 945, an SRS schedule manager 950, a pre-compensation gap manager 955, a postponement threshold manager 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The uplink scheduling manager 925 is capable of, configured to, or operable to support a means for receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The uplink transmission manager 930 is capable of, configured to, or operable to support a means for performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

In some examples, to support performing the set of repetitions of the uplink transmission, the uplink transmission puncturing manager 935 is capable of, configured to, or operable to support a means for performing the set of repetitions of the uplink transmission via the first set of resources based on the at least the subset of resources being less than or equal to the threshold quantity of resources, where respective portions of the set of repetitions of the uplink transmission scheduled in the at least the subset of resources are dropped in accordance with the scheduling conflict.

In some examples, to support performing the set of repetitions of the uplink transmission, the uplink transmission postponement manager 940 is capable of, configured to, or operable to support a means for performing the set of repetitions of the uplink transmission via the second set of resources based on the at least the subset of resources being greater than the threshold quantity of resources.

In some examples, a totality of the second set of resources is subsequent in time to the first set of resources.

In some examples, a temporally first time resource of the first set of resources is the same as a temporally first time resource of the second set of resources. In some examples, a temporally second time resource of the second set of resources is subsequent in time to a temporally second time resource of the first set of resources. In some examples, the temporally second time resource of the first set of resources includes one or more resources of the at least the subset of resources.

In some examples, the OCC configuration indicates a multiplexing order and an OCC to apply to the set of repetitions of the uplink transmission. In some examples, a total quantity of repetitions of the set of repetitions of the uplink transmission is greater than or equal to the multiplexing order.

In some examples, the second set of resources are a temporally next subsequent set of resources associated with the uplink transmission after the first set of resources without a respective scheduling conflict.

In some examples, the threshold quantity of resources is based on a SCS associated with the set of repetitions of the uplink transmission, a time-domain granularity associated with the OCC configuration, a multiplexing order associated with the OCC configuration, or a combination thereof.

In some examples, the threshold quantity of resources includes a threshold quantity of symbols.

In some examples, the other RAT schedule manager 945 is capable of, configured to, or operable to support a means for receiving an indication of a third set of resources associated with a second radio access technology, where the set of repetitions of the uplink transmission are associated with a first radio access technology, and where the scheduling conflict is based on the at least the subset of resources being included within the third set of resources.

In some examples, the SRS schedule manager 950 is capable of, configured to, or operable to support a means for receiving an indication of a third set of resources associated with SRS transmission, where the scheduling conflict is based on the at least the subset of resources being included within the third set of resources.

In some examples, the pre-compensation gap manager 955 is capable of, configured to, or operable to support a means for identifying a third set of resources associated with a pre-compensation gap associated with segmented pre-compensation for communicating with NTNs for the UE, where the scheduling conflict is based on the at least the subset of resources being included within the third set of resources.

In some examples, the postponement threshold manager 960 is capable of, configured to, or operable to support a means for receiving, via the control signaling or second control signaling, an indication of the threshold quantity of resources.

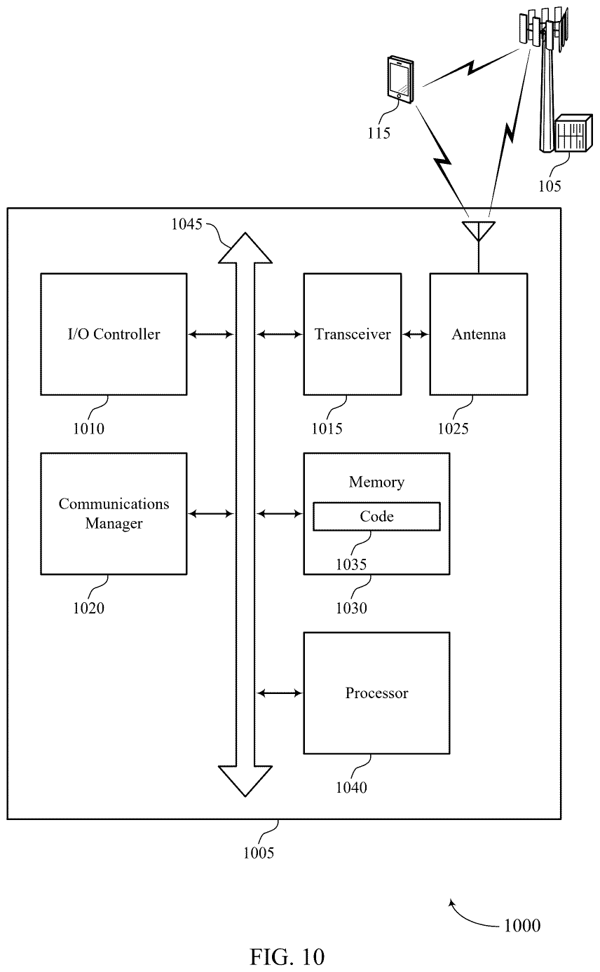

FIG. 10 shows a diagram of a system 1000 including a device 1005 that supports puncturing and postponement of uplink transmissions with OCC in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting puncturing and postponement of uplink transmissions with OCC). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The communications manager 1020 is capable of, configured to, or operable to support a means for performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

By including or configuring the communications manager 1020 in accordance with examples as described herein, the device 1005 may support techniques for improved communication reliability, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of puncturing and postponement of uplink transmissions with OCC as described herein, or the at least one processor 1040 and the at least one memory 1030 may be otherwise configured to, individually or collectively, perform or support such operations.

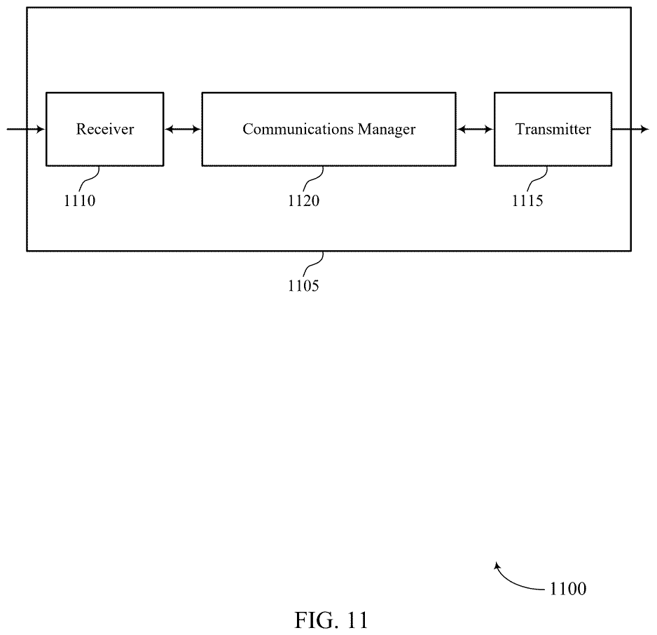

FIG. 11 shows a block diagram 1100 of a device 1105 that supports puncturing and postponement of uplink transmissions with OCC in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of puncturing and postponement of uplink transmissions with OCC as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The communications manager 1120 is capable of, configured to, or operable to support a means for obtaining, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

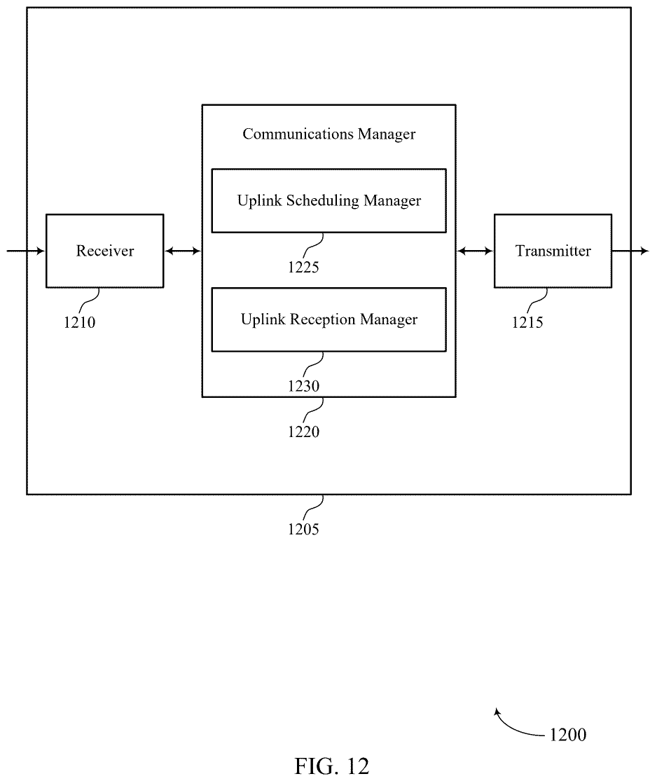

FIG. 12 shows a block diagram 1200 of a device 1205 that supports puncturing and postponement of uplink transmissions with OCC in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of puncturing and postponement of uplink transmissions with OCC as described herein. For example, the communications manager 1220 may include an uplink scheduling manager 1225 an uplink reception manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The uplink scheduling manager 1225 is capable of, configured to, or operable to support a means for outputting, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The uplink reception manager 1230 is capable of, configured to, or operable to support a means for obtaining, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

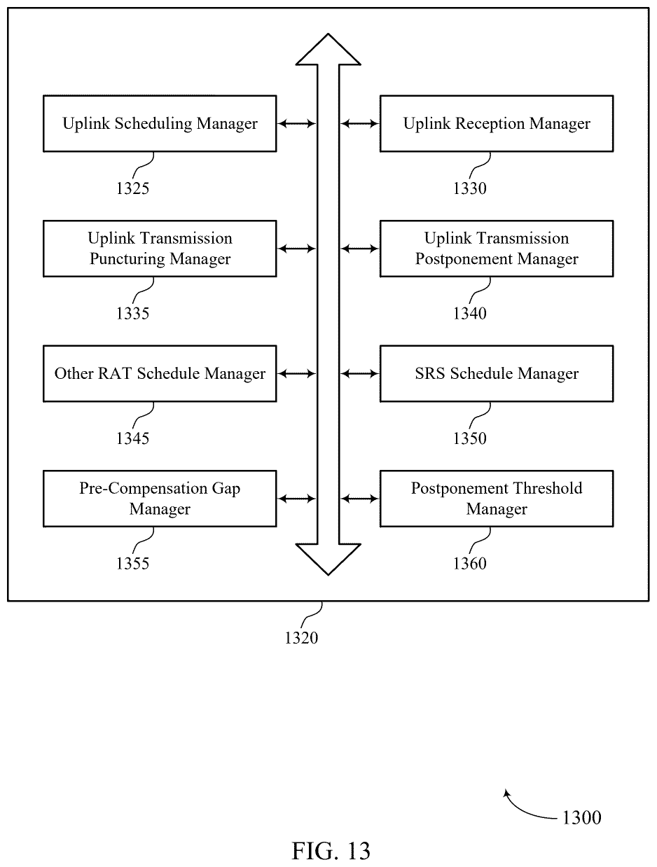

FIG. 13 shows a block diagram 1300 of a communications manager 1320 that supports puncturing and postponement of uplink transmissions with OCC in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of puncturing and postponement of uplink transmissions with OCC as described herein. For example, the communications manager 1320 may include an uplink scheduling manager 1325, an uplink reception manager 1330, an uplink transmission puncturing manager 1335, an uplink transmission postponement manager 1340, another RAT schedule manager 1345, an SRS schedule manager 1350, a pre-compensation gap manager 1355, a postponement threshold manager 1360, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The uplink scheduling manager 1325 is capable of, configured to, or operable to support a means for outputting, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The uplink reception manager 1330 is capable of, configured to, or operable to support a means for obtaining, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

In some examples, to support obtaining the set of repetitions of the uplink transmission, the uplink transmission puncturing manager 1335 is capable of, configured to, or operable to support a means for obtaining the set of repetitions of the uplink transmission via the first set of resources based on the at least the subset of resources being less than or equal to the threshold quantity of resources, where respective portions of the set of repetitions of the uplink transmission scheduled in the at least the subset of resources are dropped in accordance with the scheduling conflict.

In some examples, to support obtaining the set of repetitions of the uplink transmission, the uplink transmission postponement manager 1340 is capable of, configured to, or operable to support a means for obtaining the set of repetitions of the uplink transmission via the second set of resources based on the at least the subset of resources being greater than the threshold quantity of resources.

In some examples, a totality of the second set of resources is subsequent in time to the first set of resources.

In some examples, a temporally first time resource of the first set of resources is the same as a temporally first time resource of the second set of resources. In some examples, a temporally second time resource of the second set of resources is subsequent in time to a temporally second time resource of the first set of resources. In some examples, the temporally second time resource of the first set of resources includes one or more resources of the at least the subset of resources.

In some examples, the OCC configuration indicates a multiplexing order and an OCC to apply to the set of repetitions of the uplink transmission. In some examples, a total quantity of repetitions of the set of repetitions of the uplink transmission is greater than or equal to the multiplexing order.

In some examples, the second set of resources are a temporally next subsequent set of resources associated with the uplink transmission after the first set of resources without a respective scheduling conflict.

In some examples, the threshold quantity of resources is based on a SCS associated with the set of repetitions of the uplink transmission, a time-domain granularity associated with the OCC configuration, a multiplexing order associated with the OCC configuration, or a combination thereof.

In some examples, the threshold quantity of resources includes a threshold quantity of symbols.

In some examples, the other RAT schedule manager 1345 is capable of, configured to, or operable to support a means for obtaining an indication of a third set of resources associated with a second radio access technology, where the set of repetitions of the uplink transmission are associated with a first radio access technology, and where the scheduling conflict is based on the at least the subset of resources being included within the third set of resources.

In some examples, the SRS schedule manager 1350 is capable of, configured to, or operable to support a means for obtaining an indication of a third set of resources associated with SRS transmission, where the scheduling conflict is based on the at least the subset of resources being included within the third set of resources.

In some examples, the pre-compensation gap manager 1355 is capable of, configured to, or operable to support a means for identifying a third set of resources associated with a pre-compensation gap associated with segmented pre-compensation for communicating with NTNs for the UE, where the scheduling conflict is based on the at least the subset of resources being included within the third set of resources.

In some examples, the postponement threshold manager 1360 is capable of, configured to, or operable to support a means for outputting, for the UE and via the control signaling or second control signaling, an indication of the threshold quantity of resources.

In some examples, the uplink scheduling manager 1325 is capable of, configured to, or operable to support a means for outputting, for a second UE, second control signaling that indicates second scheduling information for a second set of repetitions of a second uplink transmission, where the second scheduling information indicates the first set of resources for the second set of repetitions of the second uplink transmission, and where the second scheduling information indicates to perform the second set of repetitions of the second uplink transmission in accordance with a second OCC configuration. In some examples, the uplink reception manager 1330 is capable of, configured to, or operable to support a means for obtaining, in association with the second UE, the second set of repetitions of the second uplink transmission in accordance with the second OCC configuration via the first set of resources or via the second set of resources based on whether the at least the subset of resources exceeds the threshold quantity of resources.

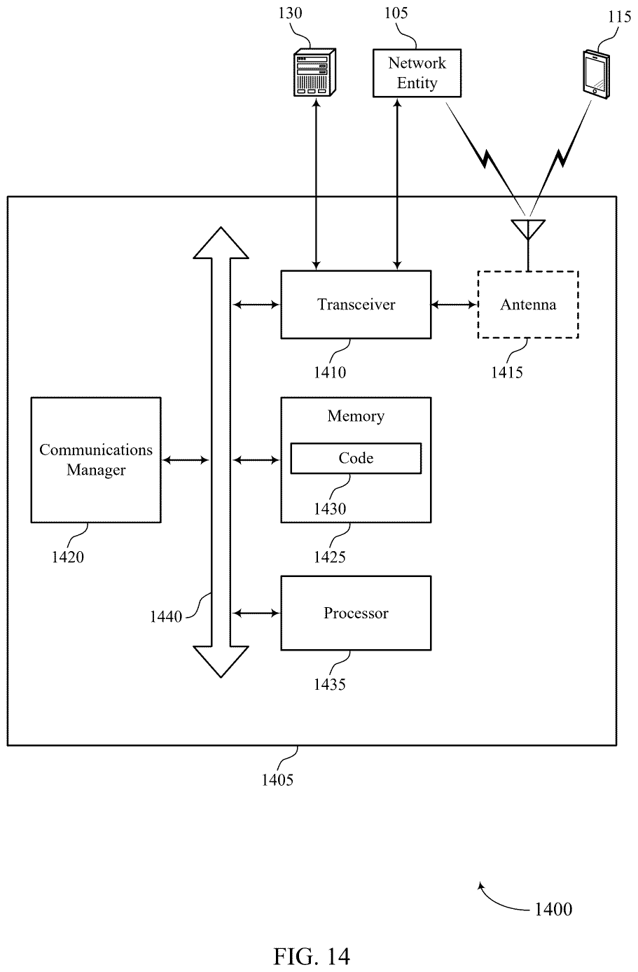

FIG. 14 shows a diagram of a system 1400 including a device 1405 that supports puncturing and postponement of uplink transmissions with OCC in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting puncturing and postponement of uplink transmissions with OCC). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The communications manager 1420 is capable of, configured to, or operable to support a means for obtaining, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources.

By including or configuring the communications manager 1420 in accordance with examples as described herein, the device 1405 may support techniques for improved communication reliability, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of puncturing and postponement of uplink transmissions with OCC as described herein, or the at least one processor 1435 and the at least one memory 1425 may be otherwise configured to, individually or collectively, perform or support such operations.

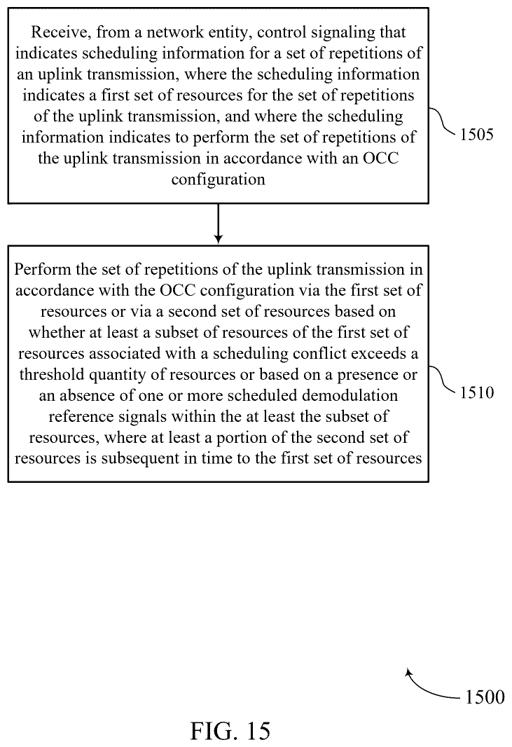

FIG. 15 shows a flowchart illustrating a method 1500 that supports puncturing and postponement of uplink transmissions with OCC in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The operations of 1505 may be performed in accordance with examples as disclosed herein. In some examples, aspects of the operations of 1505 may be performed by an uplink scheduling manager 925 as described with reference to FIG. 9.

At 1510, the method may include performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources. The operations of 1510 may be performed in accordance with examples as disclosed herein. In some examples, aspects of the operations of 1510 may be performed by an uplink transmission manager 930 as described with reference to FIG. 9.

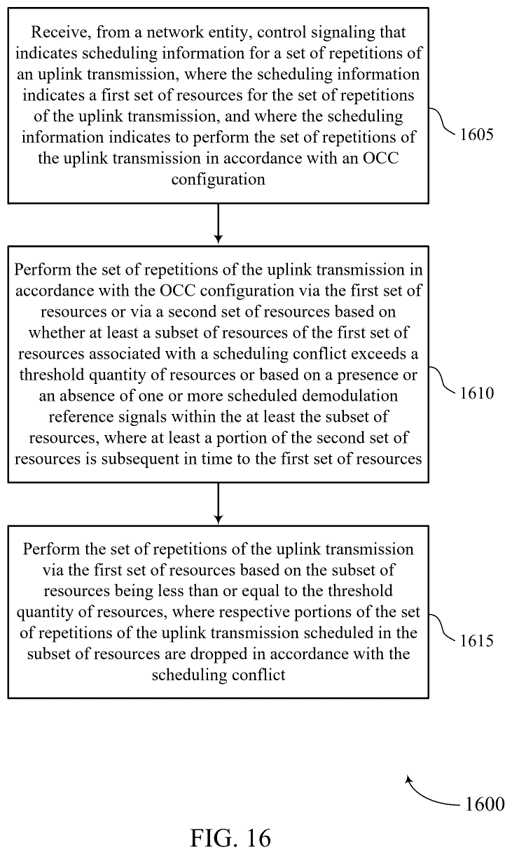

FIG. 16 shows a flowchart illustrating a method 1600 that supports puncturing and postponement of uplink transmissions with OCC in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The operations of 1605 may be performed in accordance with examples as disclosed herein. In some examples, aspects of the operations of 1605 may be performed by an uplink scheduling manager 925 as described with reference to FIG. 9.

At 1610, the method may include performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources. The operations of 1610 may be performed in accordance with examples as disclosed herein. In some examples, aspects of the operations of 1610 may be performed by an uplink transmission manager 930 as described with reference to FIG. 9.

At 1615, the method may include performing the set of repetitions of the uplink transmission via the first set of resources based on the at least the subset of resources being less than or equal to the threshold quantity of resources, where respective portions of the set of repetitions of the uplink transmission scheduled in the at least the subset of resources are dropped in accordance with the scheduling conflict. The operations of 1615 may be performed in accordance with examples as disclosed herein. In some examples, aspects of the operations of 1615 may be performed by an uplink transmission puncturing manager 935 as described with reference to FIG. 9.

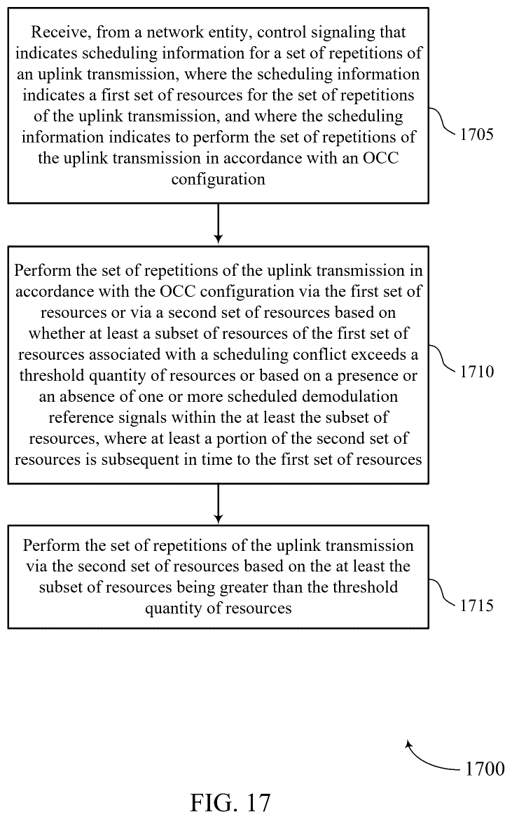

FIG. 17 shows a flowchart illustrating a method 1700 that supports puncturing and postponement of uplink transmissions with OCC in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The operations of 1705 may be performed in accordance with examples as disclosed herein. In some examples, aspects of the operations of 1705 may be performed by an uplink scheduling manager 925 as described with reference to FIG. 9.

At 1710, the method may include performing the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources. The operations of 1710 may be performed in accordance with examples as disclosed herein. In some examples, aspects of the operations of 1710 may be performed by an uplink transmission manager 930 as described with reference to FIG. 9.

At 1715, the method may include performing the set of repetitions of the uplink transmission via the second set of resources based on the at least the subset of resources being greater than the threshold quantity of resources. The operations of 1715 may be performed in accordance with examples as disclosed herein. In some examples, aspects of the operations of 1715 may be performed by an uplink transmission postponement manager 940 as described with reference to FIG. 9.

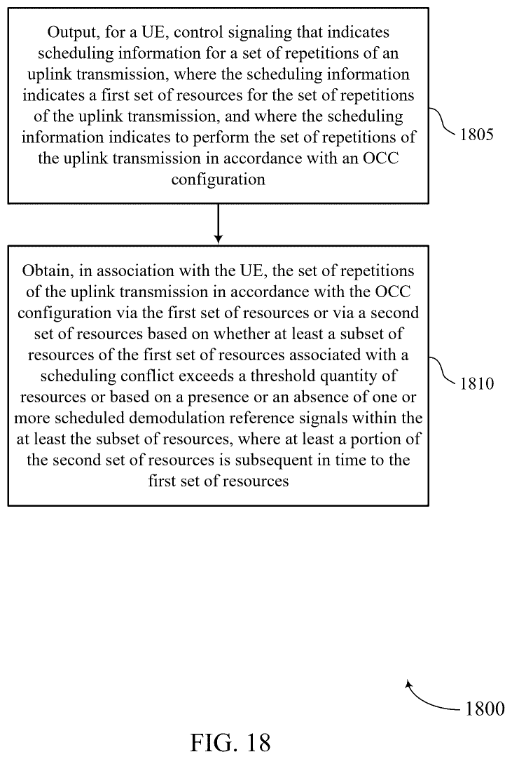

FIG. 18 shows a flowchart illustrating a method 1800 that supports puncturing and postponement of uplink transmissions with OCC in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, for a UE, control signaling that indicates scheduling information for a set of repetitions of an uplink transmission, where the scheduling information indicates a first set of resources for the set of repetitions of the uplink transmission, and where the scheduling information indicates to perform the set of repetitions of the uplink transmission in accordance with an OCC configuration. The operations of 1805 may be performed in accordance with examples as disclosed herein. In some examples, aspects of the operations of 1805 may be performed by an uplink scheduling manager 1325 as described with reference to FIG. 13.

At 1810, the method may include obtaining, in association with the UE, the set of repetitions of the uplink transmission in accordance with the OCC configuration via the first set of resources or via a second set of resources based on whether at least a subset of resources of the first set of resources associated with a scheduling conflict exceeds a threshold quantity of resources or based on a presence or an absence of one or more scheduled DMRSs within the at least the subset of resources, where at least a portion of the second set of resources is subsequent in time to the first set of resources. The operations of 1810 may be performed in accordance with examples as disclosed herein. In some examples, aspects of the operations of 1810 may be performed by an uplink reception manager 1330 as described with reference to FIG. 13.

The following provides an overview of aspects of the present disclosure:
Aspect 1: A method for wireless communications at a UE, comprising: receiving, from a network entity, control signaling that indicates scheduling information for a set of repetitions of an uplink transmission, wherein the scheduling information indicates a first set of resources for the set of repetitions of the uplink transmission, and wherein the scheduling information indicates to perform the set of repetitions of the uplink transmission in accordance with an OCC configuration; and performing the set of repetitions of the uplink transmission in accordance with the OCC configuration via the first set of resources or via a second set of resources based at least in part on whether at least a subset of resources of the first set of resources associated with a scheduling conflict exceeds a threshold quantity of resources or based at least in part on a presence or an absence of one or more scheduled DMRSs within the at least the subset of resources, wherein at least a portion of the second set of resources is subsequent in time to the first set of resources.
Aspect 2: The method of aspect 1, wherein performing the set of repetitions of the uplink transmission comprises: performing the set of repetitions of the uplink transmission via the first set of resources based at least in part on the at least the subset of resources being less than or equal to the threshold quantity of resources, wherein respective portions of the set of repetitions of the uplink transmission scheduled in the at least the subset of resources are dropped in accordance with the scheduling conflict.
Aspect 3: The method of aspect 1, wherein performing the set of repetitions of the uplink transmission comprises: performing the set of repetitions of the uplink transmission via the second set of resources based at least in part on the at least the subset of resources being greater than the threshold quantity of resources.
Aspect 4: The method of aspect 3, wherein a totality of the second set of resources is subsequent in time to the first set of resources.
Aspect 5: The method of any of aspects 3 through 4, wherein a temporally first time resource of the first set of resources is the same as a temporally first time resource of the second set of resources, a temporally second time resource of the second set of resources is subsequent in time to a temporally second time resource of the first set of resources, and the temporally second time resource of the first set of resources includes one or more resources of the at least the subset of resources.
Aspect 6: The method of any of aspects 1 through 5, wherein the OCC configuration indicates a multiplexing order and an OCC to apply to the set of repetitions of the uplink transmission, and a total quantity of repetitions of the set of repetitions of the uplink transmission is greater than or equal to the multiplexing order.
Aspect 7: The method of any of aspects 1 through 6, wherein the second set of resources are a temporally next subsequent set of resources associated with the uplink transmission after the first set of resources without a respective scheduling conflict.
Aspect 8: The method of any of aspects 1 through 7, wherein the threshold quantity of resources is based at least in part on a SCS associated with the set of repetitions of the uplink transmission, a time-domain granularity associated with the OCC configuration, a multiplexing order associated with the OCC configuration, or a combination thereof.
Aspect 9: The method of any of aspects 1 through 8, wherein the threshold quantity of resources comprises a threshold quantity of symbols.
Aspect 10: The method of any of aspects 1 through 9, further comprising: receiving an indication of a third set of resources associated with a second RAT, wherein the set of repetitions of the uplink transmission are associated with a first RAT, and wherein the scheduling conflict is based at least in part on the at least the subset of resources being included within the third set of resources.
Aspect 11: The method of any of aspects 1 through 10, further comprising: receiving an indication of a third set of resources associated with SRS transmission, wherein the scheduling conflict is based at least in part on the at least the subset of resources being included within the third set of resources.
Aspect 12: The method of any of aspects 1 through 11, further comprising: identifying a third set of resources associated with a pre-compensation gap associated with segmented pre-compensation for communicating with NTNs for the UE, wherein the scheduling conflict is based at least in part on the at least the subset of resources being included within the third set of resources.
Aspect 13: The method of any of aspects 1 through 12, further comprising: receiving, via the control signaling or second control signaling, an indication of the threshold quantity of resources.
Aspect 14: The method of any of aspects 1 through 13, wherein performing the set of repetitions of the uplink transmission comprises: performing the set of repetitions of the uplink transmission via the first set of resources based at least in part on the absence of the one or more scheduled DMRSs within the at least the subset of resources.
Aspect 15: The method of any of aspects 1 through 14, wherein performing the set of repetitions of the uplink transmission comprises: performing the set of repetitions of the uplink transmission via the second set of resources based at least in part on the presence of one or more scheduled DMRSs within the at least the subset of resources
Aspect 16: A method for wireless communications at a network entity, comprising: outputting, for a UE, control signaling that indicates scheduling information for a set of repetitions of an uplink transmission, wherein the scheduling information indicates a first set of resources for the set of repetitions of the uplink transmission, and wherein the scheduling information indicates to perform the set of repetitions of the uplink transmission in accordance with an OCC configuration; and obtaining, in association with the UE, the set of repetitions of the uplink transmission in accordance with the OCC configuration via the first set of resources or via a second set of resources based at least in part on whether at least a subset of resources of the first set of resources associated with a scheduling conflict exceeds a threshold quantity of resources or based at least in part on a presence or an absence of one or more scheduled DMRSs within the at least the subset of resources, wherein at least a portion of the second set of resources is subsequent in time to the first set of resources.
Aspect 17: The method of aspect 16, wherein obtaining the set of repetitions of the uplink transmission comprises: obtaining the set of repetitions of the uplink transmission via the first set of resources based at least in part on the at least the subset of resources being less than or equal to the threshold quantity of resources, wherein respective portions of the set of repetitions of the uplink transmission scheduled in the at least the subset of resources are dropped in accordance with the scheduling conflict.
Aspect 18: The method of any of aspects 16 through 17, wherein obtaining the set of repetitions of the uplink transmission comprises: obtaining the set of repetitions of the uplink transmission via the second set of resources based at least in part on the at least the subset of resources being greater than the threshold quantity of resources.
Aspect 19: The method of aspect 18, wherein a totality of the second set of resources is subsequent in time to the first set of resources.
Aspect 20: The method of any of aspects 18 through 19, wherein a temporally first time resource of the first set of resources is the same as a temporally first time resource of the second set of resources, a temporally second time resource of the second set of resources is subsequent in time to a temporally second time resource of the first set of resources, and the temporally second time resource of the first set of resources includes one or more resources of the at least the subset of resources.
Aspect 21: The method of any of aspects 16 through 20, wherein the OCC configuration indicates a multiplexing order and an OCC to apply to the set of repetitions of the uplink transmission, and a total quantity of repetitions of the set of repetitions of the uplink transmission is greater than or equal to the multiplexing order.
Aspect 22: The method of any of aspects 16 through 21, wherein the second set of resources are a temporally next subsequent set of resources associated with the uplink transmission after the first set of resources without a respective scheduling conflict.
Aspect 23: The method of any of aspects 16 through 22, wherein the threshold quantity of resources is based at least in part on a SCS associated with the set of repetitions of the uplink transmission, a time-domain granularity associated with the OCC configuration, a multiplexing order associated with the OCC configuration, or a combination thereof.
Aspect 24: The method of any of aspects 16 through 23, wherein the threshold quantity of resources comprises a threshold quantity of symbols.
Aspect 25: The method of any of aspects 16 through 24, further comprising: obtaining an indication of a third set of resources associated with a second RAT, wherein the set of repetitions of the uplink transmission are associated with a first RAT, and wherein the scheduling conflict is based at least in part on the at least the subset of resources being included within the third set of resources.
Aspect 26: The method of any of aspects 16 through 25, further comprising: obtaining an indication of a third set of resources associated with SRS transmission, wherein the scheduling conflict is based at least in part on the at least the subset of resources being included within the third set of resources.
Aspect 27: The method of any of aspects 16 through 26, further comprising: identifying a third set of resources associated with a pre-compensation gap associated with segmented pre-compensation for communicating with NTNs for the UE, wherein the scheduling conflict is based at least in part on the at least the subset of resources being included within the third set of resources.
Aspect 28: The method of any of aspects 16 through 27, further comprising: outputting, for the UE and via the control signaling or second control signaling, an indication of the threshold quantity of resources.
Aspect 29: The method of any of aspects 16 through 28, further comprising: outputting, for a second UE, second control signaling that indicates second scheduling information for a second set of repetitions of a second uplink transmission, wherein the second scheduling information indicates the first set of resources for the second set of repetitions of the second uplink transmission, and wherein the second scheduling information indicates to perform the second set of repetitions of the second uplink transmission in accordance with a second OCC configuration; and obtaining, in association with the second UE, the second set of repetitions of the second uplink transmission in accordance with the second OCC configuration via the first set of resources or via the second set of resources based at least in part on whether the at least the subset of resources exceeds the threshold quantity of resources.
Aspect 30: The method of any of aspects 16 through 17 or 21 through 29, wherein obtaining the set of repetitions of the uplink transmission comprises: obtaining the set of repetitions of the uplink transmission via the first set of resources based at least in part on the absence of the one or more scheduled DMRSs within the at least the subset of resources.
Aspect 31: The method of any of aspects 16 or 18 through 29, wherein obtaining the set of repetitions of the uplink transmission comprises: obtaining the set of repetitions of the uplink transmission via the second set of resources based at least in part on the presence of one or more scheduled DMRSs within the at least the subset of resources.
Aspect 32: A UE for wireless communications, comprising one or more memories storing processor-executable code, and one or more processors coupled with the one or more memories and individually or collectively operable to execute the code to cause the UE to perform a method of any of aspects 1 through 15.
Aspect 33: A UE for wireless communications, comprising at least one means for performing a method of any of aspects 1 through 15.
Aspect 34: A non-transitory computer-readable medium storing code for wireless communications, the code comprising instructions executable by one or more processors to perform a method of any of aspects 1 through 15.
Aspect 35: A network entity for wireless communications, comprising one or more memories storing processor-executable code, and one or more processors coupled with the one or more memories and individually or collectively operable to execute the code to cause the network entity to perform a method of any of aspects 16 through 31.
Aspect 36: A network entity for wireless communications, comprising at least one means for performing a method of any of aspects 16 through 31.
Aspect 37: A non-transitory computer-readable medium storing code for wireless communications, the code comprising instructions executable by one or more processors to perform a method of any of aspects 16 through 31.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, control signaling that indicates scheduling information for a set of repetitions of an uplink transmission, wherein the scheduling information indicates a first set of resources for the set of repetitions of the uplink transmission, and wherein the scheduling information indicates to perform the set of repetitions of the uplink transmission in accordance with an orthogonal cover code configuration; and
perform the set of repetitions of the uplink transmission in accordance with the orthogonal cover code configuration via the first set of resources or via a second set of resources based at least in part on whether at least a subset of resources of the first set of resources associated with a scheduling conflict exceeds a threshold quantity of resources or based at least in part on a presence or an absence of one or more scheduled demodulation reference signals within the at least the subset of resources, wherein at least a portion of the second set of resources is subsequent in time to the first set of resources.

2. The UE of claim 1, wherein, to perform the set of repetitions of the uplink transmission, the one or more processors are individually or collectively operable to execute the code to cause the UE to:
perform the set of repetitions of the uplink transmission via the first set of resources based at least in part on the at least the subset of resources being less than or equal to the threshold quantity of resources, wherein respective portions of the set of repetitions of the uplink transmission scheduled in the subset of resources are dropped in accordance with the scheduling conflict.

3. The UE of claim 1, wherein, to perform the set of repetitions of the uplink transmission, the one or more processors are individually or collectively operable to execute the code to cause the UE to:
perform the set of repetitions of the uplink transmission via the second set of resources based at least in part on the at least the subset of resources being greater than the threshold quantity of resources.

4. The UE of claim 3, wherein a totality of the second set of resources is subsequent in time to the first set of resources.

5. The UE of claim 3, wherein:
a temporally first time resource of the first set of resources is the same as a temporally first time resource of the second set of resources,
a temporally second time resource of the second set of resources is subsequent in time to a temporally second time resource of the first set of resources, and
the temporally second time resource of the first set of resources includes one or more resources of the at least the subset of resources.

6. The UE of claim 1, wherein:
the orthogonal cover code configuration indicates a multiplexing order and an orthogonal cover code to apply to the set of repetitions of the uplink transmission, and
a total quantity of repetitions of the set of repetitions of the uplink transmission is greater than or equal to the multiplexing order.

7. The UE of claim 1, wherein the second set of resources are a temporally next subsequent set of resources associated with the uplink transmission after the first set of resources without a respective scheduling conflict.

8. The UE of claim 1, wherein the threshold quantity of resources is based at least in part on a subcarrier spacing associated with the set of repetitions of the uplink transmission, a time-domain granularity associated with the orthogonal cover code configuration, a multiplexing order associated with the orthogonal cover code configuration, or a combination thereof.

9. The UE of claim 1, wherein the threshold quantity of resources comprises a threshold quantity of symbols.

10. The UE of claim 1, wherein the one or more processors are individually or collectively further operable to execute the code to cause the UE to:
receive an indication of a third set of resources associated with a second radio access technology, wherein the set of repetitions of the uplink transmission are associated with a first radio access technology, and wherein the scheduling conflict is based at least in part on the at least the subset of resources being included within the third set of resources.

11. The UE of claim 1, wherein the one or more processors are individually or collectively further operable to execute the code to cause the UE to:
receive an indication of a third set of resources associated with sounding reference signal transmission, wherein the scheduling conflict is based at least in part on the at least the subset of resources being included within the third set of resources.

12. The UE of claim 1, wherein the one or more processors are individually or collectively further operable to execute the code to cause the UE to:
identify a third set of resources associated with a pre-compensation gap associated with segmented pre-compensation for communicating with non-terrestrial networks for the UE, wherein the scheduling conflict is based at least in part on the at least the subset of resources being included within the third set of resources.

13. The UE of claim 1, wherein the one or more processors are individually or collectively further operable to execute the code to cause the UE to:
receive, via the control signaling or second control signaling, an indication of the threshold quantity of resources.

14. The UE of claim 1, wherein, to perform the set of repetitions of the uplink transmission, the one or more processors are individually or collectively operable to execute the code to cause the UE to:
perform the set of repetitions of the uplink transmission via the first set of resources based at least in part on the absence of the one or more scheduled demodulation reference signals within the at least the subset of resources.

15. The UE of claim 1, wherein, to perform the set of repetitions of the uplink transmission, the one or more processors are individually or collectively operable to execute the code to cause the UE to:
perform the set of repetitions of the uplink transmission via the second set of resources based at least in part on the presence of one or more scheduled demodulation reference signals within the at least the subset of resources.

16. A network entity, comprising:
one or more memories storing processor-executable code; and
one or more processors coupled with the one or more memories and individually or collectively operable to execute the code to cause the network entity to:
output, for a user equipment (UE), control signaling that indicates scheduling information for a set of repetitions of an uplink transmission, wherein the scheduling information indicates a first set of resources for the set of repetitions of the uplink transmission, and wherein the scheduling information indicates to perform the set of repetitions of the uplink transmission in accordance with an orthogonal cover code configuration; and
obtain, in association with the UE, the set of repetitions of the uplink transmission in accordance with the orthogonal cover code configuration via the first set of resources or via a second set of resources based at least in part on whether at least a subset of resources of the first set of resources associated with a scheduling conflict exceeds a threshold quantity of resources or based at least in part on a presence or an absence of one or more scheduled demodulation reference signals within the at least the subset of resources, wherein at least a portion of the second set of resources is subsequent in time to the first set of resources.

17. The network entity of claim 16, wherein, to obtain the set of repetitions of the uplink transmission, the one or more processors are individually or collectively operable to execute the code to cause the network entity to:
obtain the set of repetitions of the uplink transmission via the first set of resources based at least in part on the at least the subset of resources being less than or equal to the threshold quantity of resources, wherein respective portions of the set of repetitions of the uplink transmission scheduled in the at least the subset of resources are dropped in accordance with the scheduling conflict.

18. The network entity of claim 16, wherein, to obtain the set of repetitions of the uplink transmission, the one or more processors are individually or collectively operable to execute the code to cause the network entity to:
obtain the set of repetitions of the uplink transmission via the second set of resources based at least in part on the at least the subset of resources being greater than the threshold quantity of resources.

19. The network entity of claim 18, wherein a totality of the second set of resources is subsequent in time to the first set of resources.

20. A method for wireless communications at a user equipment (UE), comprising:
receiving, from a network entity, control signaling that indicates scheduling information for a set of repetitions of an uplink transmission, wherein the scheduling information indicates a first set of resources for the set of repetitions of the uplink transmission, and wherein the scheduling information indicates to perform the set of repetitions of the uplink transmission in accordance with an orthogonal cover code configuration; and
performing the set of repetitions of the uplink transmission in accordance with the orthogonal cover code configuration via the first set of resources or via a second set of resources based at least in part on whether at least a subset of resources of the first set of resources associated with a scheduling conflict exceeds a threshold quantity of resources or based at least in part on a presence or an absence of one or more scheduled demodulation reference signals within the at least the subset of resources, wherein at least a portion of the second set of resources is subsequent in time to the first set of resources.
